(19) United States
(12) Patent Application Publication
(10) Pub. No.: US 2008/0174627 A1
(43) Pub. Date: Jul. 24, 2008

(54) METHOD FOR CONTROLLING DROPLET DISCHARGE HEAD, DRAWING METHOD, AND DROPLET DISCHARGE DEVICE

(75) Inventor: Nobuaki KAMIYAMA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/872,925

(22) Filed: Oct. 16, 2007

(30) Foreign Application Priority Data
Oct. 26, 2006 (JP) 2006-290816

(51) Int. Cl. B41J 29/38

(52) U.S. Cl. 347/17

(57) ABSTRACT

A droplet discharge device includes: a droplet discharge head that pressurizes a portion defining a cavity so as to discharge a functional liquid from a nozzle communicating with the portion defining a cavity; and a table moving the work relatively to the droplet discharge head. In the device, the droplet discharge head includes a pressurizing part that pressurizes the portion defining a cavity. In a case where the functional liquid is not discharged from the nozzle, the pressurizing part pressurizes the portion defining a cavity a plurality of times in succession so as to change pressure on the functional liquid at an extent not discharging the functional liquid from the nozzle; and a frequency of variation of pressure for pressurizing the portion defining a cavity is changed so as to pressurize the portion defining a cavity by the pressurizing part.

### BACKGROUND

1. Technical Field

The present invention relates to a method for controlling a droplet discharge head, a drawing method, and a droplet discharge device.

2. Related Art

Ink-jet droplet discharge devices are conventionally known as a device that discharges droplets to a work. The droplet discharge devices include a table that places a work thereon such as a substrate and moves it in one direction, and a carriage that moves above the table along a guide rail disposed in a direction perpendicular to the direction in which the table moves. The carriage includes an ink-jet head (hereinafter, referred to as “a droplet discharge head”) that discharges and applies droplets to the work.

Various kinds of materials are used as a functional liquid to be discharged and applied in droplets to the work. The viscosity of many of the materials used as a functional liquid varies depending on a temperature, and the variation of the viscosity changes the fluid resistance. The change of the fluid resistance changes a flow-velocity of the functional liquid that flows in a flow channel of the droplet discharge head. The change of the flow-velocity of the functional liquid changes a discharge amount per one dot, making difficult to apply desired amount of functional liquid.

JP-A-2003-26679 discloses a method for controlling the discharge amount per one dot, for example. This method controls a driving waveform for driving a piezoelectric element which pressurizes a cavity of the droplet discharge head, a driving voltage for the same, and a temperature of a liquid to be discharged. Further, the method arranges a heater at the droplet discharge head, a supply pipe, and a tank so as to control the temperature of the liquid.

When the cavity of the droplet discharge head is pressurized, portion of an energy that is given for an action of the piezoelectric element is converted into heat, causing a rise of the temperature of the droplet discharge head. Further, when the piezoelectric element is not driven, the piezoelectric element does not generate heat and the droplet discharge head releases its heat, causing a fluctuation of the temperature. The method for heating the droplet discharge head, the supply pipe, and the tank with the heater has been effective to warm the device and make the liquid temperature a desired temperature in a short period of time. On the other hand, even in the method in which the heater controls the temperature fluctuation caused by the action of the droplet discharge head to stabilize the temperature at the predetermined temperature, the control sometimes does not correspond to the fluctuation of the liquid temperature.

### SUMMARY

An advantage of the present invention is to provide a method for controlling a droplet discharge head that can accurately control a discharge amount, a drawing method, and a droplet discharge device.

A droplet discharge device according to a first aspect of the invention includes: a droplet discharge head that pressurizes a portion defining a cavity so as to discharge a functional liquid from a nozzle communicating with the portion defining a cavity; and a table moving the work relatively to the droplet discharge head. In the device, the droplet discharge head includes a pressurizing part that pressurizes the portion defining a cavity. In a case where the functional liquid is not discharged from the nozzle, the pressurizing part pressurizes the portion defining a cavity a plurality of times in succession so as to change pressure on the functional liquid at an extent not discharging the functional liquid from the nozzle. A frequency of variation of pressure for pressurizing the portion defining a cavity is changed so as to pressurize the portion defining a cavity by the pressurizing part.

According to the device of the first aspect, the droplet discharge device includes the droplet discharge head having the portion defining a cavity and the nozzle communicating with the portion defining a cavity. In addition, the droplet discharge head has the pressurizing part pressurizing the portion defining a cavity so as to discharge the functional liquid from the nozzle. Further, the droplet discharge device includes a table so as to move the work relatively to the droplet discharge head, discharging and applying the functional liquid to a desired area of the work. The pressurizing part pressurizes the portion defining a cavity a plurality of times in succession at an extent not discharging the functional liquid from the nozzle so as to change the pressure on the functional liquid.

The viscosity of the functional liquid varies depending on the change of its temperature. When the functional liquid passes through a flow channel such as the nozzle while being pressurized in the droplet discharge head, the fluid resistance thereof varies, changing the discharge amount of the functional liquid that is discharged from the nozzle. Therefore, in a case where the functional liquid is discharged with small temperature change, the functional liquid can be controlled to be discharged with accurate discharge amount, compared to a case with large temperature change.

In a case where the pressurizing part is not operated, the droplet discharge head releases its heat to be cooled. On the other hand, in a case where the pressurizing part is operated at an extent not discharging the functional liquid, a portion of energy generated in pressurizing by the pressurizing part is converted into heat. Thus the droplet discharge head generates the heat. The temperature of the droplet discharge head that generates the heat does not easily decrease.

In a case where the functional liquid is not discharged from the nozzle, the pressurizing part pressurizes the portion defining a cavity a plurality of times in succession at an extent not discharging the functional liquid from the nozzle so as to change the pressure on the functional liquid. The pressurizing part changes a frequency of variation of pressure for pressurizing the portion defining a cavity so as to pressurize the portion defining a cavity.

When the pressurizing part pressurizes the portion defining a cavity, the frequency of the pressure variation is changed so as to be able to change the energy that is given to the droplet discharge head by the pressurizing part. In a case where the amount of energy that is given to the droplet discharge head by the pressurizing part is changed at several stages, energy that approximates the energy corresponding to the heat amount released by the droplet discharge head is supplied, easily stabilizing the temperature of the droplet discharge head.

On the other hand, in a case where the functional liquid is not discharged from the nozzle and there is single kind of amount of energy that is given to the droplet discharge head by the pressurizing part, predetermined amount of energy is supplied to the droplet discharge head. At this time, the amount of energy that is released by the droplet discharge head varies depending on the temperature and the flow-velocity of the fluid flowing around the droplet discharge head, so that the amount of energy that is released by the droplet discharge head is sometimes different from the amount of energy that is supplied to the droplet discharge head. Thus, the temperature of the droplet discharge head varies depending on the state of the fluid flowing around the droplet discharge head.

Therefore, in the case where the amount of energy that is given to the portion defining a cavity by the pressurizing part is changed corresponding to the temperature of the droplet discharge head, the temperature of the droplet discharge head can be more easily stabilized than the case where there is only single kind of amount of energy that is given to the portion defining a cavity by the pressurizing part. Consequently, the functional liquid can be controlled to be discharged with accurate discharge amount.

The droplet discharge device of the aspect further includes a blowing part producing air-current that transfers to remove heat generated by the droplet discharge device. In a case where the functional liquid is not discharged from the nozzle, the pressurizing part pressurizes the portion defining a cavity with high frequency of variation of pressure for pressurizing the portion defining a cavity when the droplet discharge head is positioned where a wind-velocity is high, compared to a frequency when the droplet discharge head is positioned where the wind-velocity is low.

Here, the wind-velocity denotes a flow-velocity at which gas in the droplet discharge device flows.

According to the device of the aspect, the droplet discharge device includes the blowing part. Due to the blowing part, the fluid flows in the droplet discharge device, transferring and removing the heat generated by the droplet discharge device. In a case where the droplet discharge head is positioned where the wind-velocity is high, the heat generated by the droplet discharge head is removed and the droplet discharge head is cooled more quickly than in a case where the droplet discharge head is positioned where the wind-velocity is low. Here, the fluid may be nitrogen, and inert gas such as argon, and helium as well as air.

In terms of the droplet discharge heads having same heat capacity, the droplet discharge head that is cooled quickly needs energy corresponding to larger heat quantity than the droplet discharge head that is cooled slowly needs, in order to stabilize the temperature thereof.

The pressurizing part can supply larger energy in a case where the frequency of variation of pressure for pressurizing the portion defining a cavity is made high than in a case where the frequency is low. Since a portion of the energy that is supplied is converted into heat, the pressurizing part can supply larger quantity of heat to the droplet discharge head in a case where the frequency of variation of pressure for pressurizing the portion defining a cavity is high.

Therefore, when the droplet discharge head is positioned where the wind-velocity is high, the frequency of variation of pressure for pressurizing the portion defining a cavity is made high so as to more easily stabilize the temperature of the droplet discharge head, compared to when it is positioned where the wind-velocity is low. Consequently, the functional liquid can be controlled to be discharged with accurate discharge amount.

In the droplet discharge device of the aspect, a plurality of the droplet discharge heads may be included; and in a case where the functional liquid is not discharged from the nozzle, the pressurizing part may pressurize the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

According to the device of the aspect, the droplet discharge device includes the plurality of droplet discharge heads. The wind-velocity of gas flowing in the droplet discharge device is not even such that the wind-velocity of the gas is high some places and it is low in other places in the device. In the case where the gas flows around the plurality of droplet discharge heads, some droplet discharge heads are positioned where the wind-velocity of the flowing gas is high and other droplet discharge heads are positioned where the wind-velocity of the gas is low. The droplet discharge heads positioned where the wind-velocity of the flowing gas is high are cooled more quickly because the heat is easily transferred to be removed than the droplet discharge heads positioned where the wind-velocity of the gas is low.

In terms of the droplet discharge heads having same heat capacity, the droplet discharge head that is cooled quickly needs energy corresponding to larger heat quantity than the droplet discharge head that is cooled slowly needs, in order to stabilize the temperature thereof.

Therefore, in terms of the plurality of droplet discharge heads, in a case where the frequency of variation of pressure is made high, the pressurizing head can more easily stabilize the temperature of the droplet discharge heads positioned where the wind-velocity is high, compared to the frequency employed in the droplet discharge heads positioned where the wind-velocity is low. Consequently, the functional liquid can be controlled to be discharged with accurate discharge amount.

The droplet discharge device of the aspect further includes a measurement part measuring a temperature of the droplet discharge head. In the device, in a case where the functional liquid is not discharged from the nozzle, the pressurizing part may pressurize the portion defining a cavity with a high frequency of variation of pressure for pressurizing the portion defining a cavity when the temperature of the droplet discharge head is low, compared to a frequency of variation of pressure for pressurizing the portion defining a cavity when the temperature of the droplet discharge head is high.

According to the device of the aspect, the droplet discharge device includes the measurement part so as to measure the temperature thereof. In a case where the functional liquid is not discharged, the portion defining a cavity is pressurized. The temperature of some droplet discharge heads is relatively high, and the temperature of other droplet discharge heads relatively low. In a case where the measurement part measures the temperature of the droplet discharge head to recognize that the temperature is high, the portion defining a cavity is pressurized with low frequency. In a case where the temperature of the droplet discharge heads is low, the portion defining a cavity is pressurized with high frequency.

The pressurizing part can supply higher energy to the droplet discharge head in a case where the portion defining a cavity is pressurized with high frequency, compared to a case with low frequency. A portion of the energy is converted into heat, so that the pressurizing part can supply higher energy to the droplet discharge head in a case where the portion defining a cavity is pressurized with high frequency, compared to a case with low frequency.

In a case where the temperature of the droplet discharge head is low, the portion defining a cavity is pressurized with high frequency so as to be able to raise the temperature in a shorter period of time than pressurized with low frequency. On the other hand, in a case where the temperature of the droplet discharge heads is high, the portion defining a cavity is pressurized with low frequency so as to heat with small quantity of heat, being able to prevent the temperature from rising excessively. Thus, the temperature of the droplet discharge heads is easily stabilized. Consequently, the functional liquid can be controlled to be discharged with accurate discharge amount.

In the droplet discharge device of the aspect, a plurality of the droplet discharge heads may be included; and in a case where the functional liquid is not discharged from the nozzle, the pressurizing part may pressurize the portion defining a cavity with a high frequency of variation of pressure for pressurizing the portion defining a cavity when the temperature of the droplet discharge head is low, compared to a frequency of variation of pressure for pressurizing the portion defining a cavity when the temperature of the droplet discharge head is high.

According to the device of the aspect, the droplet discharge device includes the plurality of droplet discharge heads. The temperatures of the plurality of the droplet discharge heads are not even, so that the temperature of some droplet discharge heads is low and the temperature of other droplet discharge heads is high. In a case where the measurement part measures the temperature of the droplet discharge heads to recognize that the temperature is high, the pressurizing part pressurizes the portion defining a cavity with low frequency. In a case where the temperature of the droplet discharge heads is low, the pressurizing part pressurizes the portion defining a cavity with high frequency.

In a case where the temperature of the plurality of the droplet discharge heads is low, the portion defining a cavity is pressurized with high frequency so as to be able to supply larger energy, being able to raise the temperature in a shorter period of time than pressurized with low frequency. On the other hand, in a case where the temperature of the droplet discharge heads is high, the portion defining a cavity is pressurized with low frequency so as to heat with small quantity of heat, being able to prevent the temperature from rising excessively. Thus, the temperature of the droplet discharge heads is easily stabilized. Consequently, the functional liquid can be controlled to be discharged with accurate discharge amount.

In the device of the aspect, the pressurizing part may change amplitude of pressure for pressurizing the portion defining a cavity instead of the frequency of variation of pressure for pressurizing the portion defining a cavity, so as to pressurize the portion defining a cavity.

According to the device of the aspect, in a case the functional liquid is not discharged from the nozzle, the pressurizing part changes the pressure amplitude of the pressure variation so as to pressurize the portion defining a cavity. The pressurizing part needs large amount of energy to pressurize the portion defining a cavity largely, and needs small amount of energy to pressurize the portion defining a cavity weakly. Therefore, there is a correlative relation between the pressure amplitude for changing the pressure to pressurize the portion defining a cavity and energy that is supplied. Since a portion of the energy that is supplied to the droplet discharge head is converted into heat, the pressurizing part can supply heat to the droplet discharge head corresponding to the temperature of the droplet discharge head by changing the pressure amplitude of the pressure variation and pressurizing the portion defining a cavity.

In the device of the aspect, the pressurizing part may change a duty ratio of variation of pressure for pressurizing the portion defining a cavity instead of the frequency of variation of pressure for pressurizing the portion defining a cavity, so as to pressurize the portion defining a cavity.

Here, the duty ratio of the pressure variation is a ratio of time to pressurize the portion defining a cavity within one wavelength of the pressure variation. If the duty ratio of the pressure variation is 0.1, for example, the portion defining a cavity is pressurized for a time corresponding to the 10% length of one wavelength.

According to the device of the aspect, in a case where the functional liquid is not discharged from the nozzle, the pressurizing part changes the duty ratio of the pressure variation at a plurality of steps so as to pressurize the portion defining a cavity. The pressurizing part needs large amount of energy to pressurize the portion defining a cavity for a long period of time, and needs small amount of energy to pressurize the portion defining a cavity for a short period of time. Therefore, there is a correlative relation between the duty ratio of the pressure variation in pressurizing the portion defining a cavity and energy that is supplied. Since a portion of the energy that is supplied to the droplet discharge head is converted into heat, the pressurizing part can supply heat to the droplet discharge head corresponding to the temperature of the droplet discharge head by changing the duty ratio of the pressure variation at the plurality of steps and pressurizing the portion defining a cavity.

The method for drawing, according to a second aspect of the invention, includes: (a) pressurizing the portion defining a cavity with a pressurizing part of a droplet discharge head; (b) discharging a functional liquid from a nozzle communicating with a portion defining a cavity to a work; and one of (c) cleaning the nozzle, (d) measuring a discharge amount of the functional liquid discharged from the nozzle, and (e) waiting without discharging the functional liquid. In the method, in a case where the functional liquid is not discharged from the nozzle, the pressurizing part pressurizes the portion defining a cavity a plurality of times in succession with a different frequency between the step (a), (b) and the steps (c), (d), (e) so as to change pressure on the functional liquid at an extent not discharging the functional liquid from the nozzle.

According to the method of the second aspect, the droplet discharge head having the portion defining a cavity and the nozzle communicating with the portion defining a cavity is used in the method. In addition, the droplet discharge head has the pressurizing part that pressurizes the portion defining a cavity so as to discharge the functional liquid from the nozzle. The method includes a drawing process and a maintenance process.

In the drawing process, the functional liquid is discharged so as to draw on the work. The maintenance process includes cleaning, discharge amount measuring, and waiting without discharge the functional liquid. In the cleaning, the functional liquid is discharged to a flushing unit so as to shift the functional liquid within the droplet discharge head. Further, in a case where there is solid matter in a flow channel of the droplet discharge head, the droplet discharge head discharges the solid matter together with the functional liquid so as to clean the flow channel. Further, a nozzle plate provided with the nozzle is wiped so as to be cleaned. In the discharge amount measuring, the discharge amount of the functional liquid discharged from the nozzle is measured. In the waiting, the functional liquid is not discharged.

The viscosity of the functional liquid varies in accordance with the change of its temperature. When the functional liquid passes through the flow channel such as the nozzle while being pressurized in the droplet discharge head, the fluid resistance thereof varies, changing the discharge amount of the functional liquid that is discharged from the nozzle. Therefore, in a case where the functional liquid is discharged with small temperature change, the functional liquid can be controlled to be discharged with accurate discharge amount, compared to a case with large temperature change.

Opposed to the droplet discharge head, the work is positioned in the drawing process while a device for cleaning or a device for measuring is positioned in the maintenance process. In the drawing process and the maintenance process, gas flows at the periphery of the droplet discharge head. Here, since an object that is positioned opposed to the droplet discharge head is different in the drawing process and in the maintenance process, the fluid resistance at the periphery of the droplet discharge head is different. Therefore, the wind-velocity of the gas that flows at the periphery is different in the drawing process and in the maintenance process. In addition, the wind-velocity of the gas that flows from the air controlling device, the wind-velocity of the gas that flows at the periphery of the droplet discharge head is different in the drawing process and in the maintenance process.

When the fluid passes through while contacting the droplet discharge head, the fluid conducts the heat of the droplet discharge head to cool the head. In this case, the fluid having high flow-velocity conducts the heat in a shorter period of time than that having low flow-velocity, so that the droplet discharge head contacting the fluid having high flow-velocity is cooled in a shorter period of time.

In terms of the droplet discharge heads having same heat capacity, the droplet discharge head that is cooled quickly needs energy corresponding to larger heat quantity than the droplet discharge head that is cooled slowly needs, in order to stabilize the temperature thereof.

The pressurizing part can supply larger energy in a case where the frequency of variation of pressure for pressurizing the portion defining a cavity is high compared to a case where the frequency is low. Since a portion of the energy that is supplied is converted into heat, the pressurizing part can supply large quantity of heat to the droplet discharge head in a case where the frequency of variation of pressure for pressurizing the portion defining a cavity is high.

Therefore, in a process of a case where the droplet discharge head is positioned where the wind-velocity is high, the frequency of variation of pressure for pressurizing the portion defining a cavity is made higher so as to more easily stabilize the temperature of the droplet discharge head, compared to a frequency in a process of a case where the head is positioned where the wind-velocity is low. Consequently, the functional liquid can be controlled to be discharged with accurate discharge amount.

A method for drawing according to a third aspect of the invention includes: pressurizing a portion defining a cavity with a pressurizing part of a droplet discharge head; discharging a functional liquid from a nozzle communicating with the portion defining a cavity to a work; and pressurizing the portion defining a cavity a plurality of times in succession with the pressurizing part at an extent not discharging the functional liquid from the nozzle so as to change pressure on the functional liquid in a case where the functional liquid is not discharged from the nozzle. In the device, the pressurizing part pressurizes the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

According to the method of the third aspect, the droplet discharge head includes the portion defining a cavity, the nozzle communicating with the portion defining a cavity, and the pressurizing part that pressurizes the portion defining a cavity. The plurality of droplet discharge heads discharge the functional liquid from the nozzle such that the pressurizing part thereof pressurizes the portion defining a cavity, so as to draw on the work.

In a case where the functional liquid is not discharged from the nozzle, the pressurizing part pressurizes the portion defining a cavity a plurality of times in succession at an extent not discharging the functional liquid from the nozzle so as to change the pressure on the functional liquid. At this time, a portion of energy for pressurizing the portion defining a cavity is converted into heat, heating the droplet discharge head.

In a case the plurality of droplet discharge head are driven, the wind-velocity of the gas contacting the droplet discharge heads is different at each of the heads. In a case where the plurality of droplet discharge heads are arranged without being given any space therebetween, for example, there is no space where the gas flows at the center while there is a space where the gas flows around the droplet discharge heads arranged at ends. Here, the gas hardly flows at the center, so that the wind-velocity is low, while the gas easily flows at the ends, so that the wind-velocity is high. The droplet discharge heads positioned where the wind-velocity of the flowing gas is high are cooled more quickly because the heat is easily transferred to be removed than the droplet discharge heads positioned where the wind-velocity of the gas is low.

In terms of the droplet discharge heads having same heat capacity, the droplet discharge head that is cooled quickly needs larger heat quantity than the droplet discharge head that is cooled slowly, in order to stabilize the temperature thereof.

Therefore, in terms of the plurality of droplet discharge heads, the temperature of the droplet discharge heads is easily stabilized in a case where the pressurizing part pressurizes the portion defining a cavity with a higher frequency of variation of pressure for pressurizing the portion defining a cavity when the droplet discharge heads are positioned where the wind-velocity is high, compared to a frequency when the droplet discharge heads are positioned where the wind-velocity is low. Consequently, the functional liquid can be controlled to be discharged with accurate discharge amount.

A method for drawing according to a fourth aspect of the invention includes: pressurizing a portion defining a cavity with a pressurizing part of a droplet discharge head; discharging a functional liquid from a nozzle communicating with the portion defining a cavity to a work; pressurizing the portion defining a cavity a plurality of times in succession with the pressurizing part at an extent not discharging the functional liquid from the nozzle so as to change pressure on the functional liquid in a case where the functional liquid is not discharged from the nozzle; and measuring a temperature of the droplet discharge head with a measurement part. In the device, the pressurizing part pressurizes the portion defining a cavity with a high frequency of variation of pressure for pressurizing the portion defining a cavity when a temperature of the droplet discharge head is low, compared to a frequency of variation of pressure for pressurizing the portion defining a cavity when the temperature of the droplet discharge head is high.

According to the method of the fourth aspect, the droplet discharge head includes the portion of portion defining a cavity, the nozzle communicating with the portion defining a cavity, the pressurizing part that pressurizes the portion defining a cavity, and the measurement part. The plurality of droplet discharge heads discharge the functional liquid from the nozzle such that the pressurizing part thereof pressurizes the portion defining a cavity, so as to draw on the work. The measurement part measures the temperature of the droplet discharge heads.

In a case where the functional liquid is not discharged from the nozzle, the pressurizing part pressurizes the portion defining a cavity a plurality of times in succession at an extent not discharging the functional liquid from the nozzle so as to change the pressure on the functional liquid. At this time, a portion of energy for pressurizing the portion defining a cavity is converted into heat, heating the droplet discharge heads.

The temperature of some droplet discharge heads is relatively high, and the temperature in other droplet discharge heads is relatively low. The measurement part measures the temperature of the droplet discharge heads. In a case where the temperature of the droplet discharge heads is high, the portion defining a cavity is pressurized with low frequency. In a case where the temperature of the droplet discharge heads is low, the portion defining a cavity is pressurized with high frequency.

The pressurizing part can supply higher energy to the droplet discharge head in a case where the portion defining a cavity is pressurized with high frequency, compared to a case where the portion defining a cavity is pressurized with low frequency. A portion of the energy is converted into heat, so that the pressurizing part can supply higher energy to the droplet discharge head in a case where the portion defining a cavity is pressurized with high frequency, compared to a case with low frequency.

In the droplet discharge heads having low temperature, the temperature can be raised in a shorter period of time in a case where the portion defining a cavity is pressurized with high frequency, compared to a case pressurized with low frequency. On the other hand, in the droplet discharge heads having high temperature, the portion defining a cavity is pressurized with low frequency so as to heat with small quantity of heat, being able to prevent the temperature from rising excessively. Thus, the temperature of the droplet discharge heads is easily stabilized. Consequently, the functional liquid can be controlled to be discharged with accurate discharge amount.

In the method of the aspect, the pressurizing part may change amplitude of pressure for pressurizing the portion defining a cavity instead of the frequency of variation of pressure for pressurizing the portion defining a cavity, so as to pressurize the portion defining a cavity.

According to the method of the aspect, in a case the functional liquid is not discharged from the nozzle, the pressurizing part changes the pressure amplitude for the pressure variation so as to pressurize the portion defining a cavity. The pressurizing part needs large amount of energy to pressurize the portion defining a cavity strongly, and needs small amount of energy to pressurize the portion defining a cavity weakly. Therefore, there is a correlative relation between the pressure amplitude of variation of pressure for pressurizing the portion defining a cavity and energy that is supplied. In addition, a portion of the energy that is supplied to the droplet discharge head is converted into heat. Therefore, the pressurizing part changes the pressure amplitude of the pressure variation so as to pressurize the portion defining a cavity, thereby being able to supply heat to the droplet discharge head corresponding to the temperature of it.

In the method of the aspect, the pressurizing part may change a duty ratio of variation of pressure for pressurizing the portion defining a cavity instead of the frequency of variation of pressure for pressurizing the portion defining a cavity, so as to pressurize the portion defining a cavity.

According to the method of the aspect, in a case the functional liquid is not discharged from the nozzle, the pressurizing part changes the pressure amplitude of the pressure variation at a plurality of steps so as to pressurize the portion defining a cavity. The pressurizing part needs large amount of energy to pressurize the portion defining a cavity for a long period of time, and needs small amount of energy to pressurize the portion defining a cavity for a short period of time. Therefore, there is a correlative relation between the duty ratio of variation of pressure for pressurizing the portion defining a cavity and energy that is supplied. A portion of the energy that is supplied to the droplet discharge head is converted into heat. Therefore, the pressurizing part changes the duty ratio of the pressure variation so as to pressurize the portion defining a cavity at the plurality of steps, being able to supply heat to the droplet discharge head corresponding to the temperature of it.

A method for controlling a droplet discharge head, according to a fifth aspect of the invention, that pressurizes a portion defining a cavity with a pressurizing part thereof so as to discharge a functional liquid from a nozzle communicating with the portion defining a cavity to a work, includes: pressurizing the portion defining a cavity with the pressurizing part in response to a driving signal from a pressurization controlling part so as to change pressure on the functional liquid. In the method, in a case where the droplet discharge head does not discharge the functional liquid from the nozzle thereof, the pressurizing part may pressurize the portion defining a cavity a plurality of times in succession at an extent not discharging the functional liquid from the nozzle; and the pressurization controlling part may change a frequency of variation of pressure for pressurizing the portion defining a cavity so as to control the pressurizing part.

According to the method of the fifth aspect, the droplet discharge head includes the portion defining the portion defining a cavity, and the nozzle communicating with the portion defining a cavity. In addition, the droplet discharge head includes the pressurizing part that pressurizes the portion defining a cavity so as to discharge the functional liquid from the nozzle. The pressurizing part receives the driving signal from the pressurization controlling part so as to pressurize the portion defining a cavity. Then in a case where the functional liquid is not discharged from the nozzle, the pressurizing part pressurizes the portion defining a cavity plurality of times in succession at an extent not discharging the functional liquid from the nozzle so as to change the pressure on the functional liquid. At this time, the pressurization controlling part changes the frequency of the pressure for pressurizing the portion defining a cavity so as to control the pressurizing part.

The viscosity of the functional liquid varies depending on the change of its temperature. When the functional liquid passes through a flow channel such as the nozzle while being pressurized in the droplet discharge head, the fluid resistance thereof varies, changing the discharge amount of the functional liquid that is discharged from the nozzle. Therefore, in a case where the functional liquid is discharged with small temperature change compared to a case with large temperature change, the functional liquid can be controlled to be discharged with accurate discharge amount.

In a case where the pressurizing part is not operated, the droplet discharge head releases its heat to be cooled. On the other hand, in a case where the pressurizing part is operated at an extent not discharging the functional liquid, a portion of energy generated in pressurizing by the pressurizing part is converted into heat. Thus the droplet discharge head generates the heat. The temperature of the droplet discharge head that generates the heat does not easily decrease.

In a case where the functional liquid is not discharged from the nozzle, the pressurizing part pressurizes the portion defining a cavity plurality of times in succession at an extent not discharging the functional liquid from the nozzle so as to change the pressure on the functional liquid. At this time, the pressurizing part changes a frequency of variation of pressure for pressurizing the portion defining a cavity so as to pressurize the portion defining a cavity.

In pressurizing the portion defining a cavity, the pressurizing part changes the frequency of the pressure variation so as to be able to change the energy that is given to the droplet discharge head thereby. In a case where the pressurizing part changes the amount of energy that is given to the droplet discharge head by the pressurizing part at several steps, energy that approximates the energy corresponding to the amount of heat released by the droplet discharge head is supplied so as to easily stabilize the temperature of the droplet discharge head.

On the other hand, in a case where the functional liquid is not discharged from the nozzle and there is single kind of amount of energy that is given to the droplet discharge head by the pressurizing part, predetermined amount of energy is supplied to the droplet discharge head. At this time, the amount of energy that is released by the droplet discharge head is sometimes different from the amount of energy that is supplied to the droplet discharge head. In this case, the pressurizing part is operated until the temperature of the droplet discharge head reaches the desired temperature so as to supply energy to the droplet discharge head. Here, in order to prevent the temperature of the droplet discharge head from rising excessively, the pressurizing part is stopped at the desired temperature of the droplet discharge head so as to stop supplying the energy. Due to this stop of the energy supply, the droplet discharge head releases the heat to decrease the temperature thereof. When the temperature falls down to the predetermined temperature, the energy supply starts again. Namely, the frequency that the energy supply and the supply stop are repeated increases, fluctuating the temperature of the droplet discharge head.

Therefore, the temperature of the droplet discharge head can be more easily stabilized in a case where the pressurization controlling part changes the frequency of the pressure for pressurizing the portion defining a cavity corresponding to the temperature of the droplet discharge head so as to change the amount of energy that is given to the portion defining a cavity with the pressurizing part than in a case where there is only single kind of amount of energy that is given to the portion defining a cavity. Consequently, the functional liquid can be controlled to be discharged with accurate discharge amount.

In the method for controlling a droplet discharge head of the aspect, the pressurization controlling part may control a plurality of the droplet discharge heads all together; and in a case where the pressurization controlling part does not discharge the functional liquid from the nozzle thereof, the pressurization controlling part may control the pressurizing part such that the pressurizing part pressurizes the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

According to the method, the pressurization controlling part controls the plurality of droplet discharge heads all together.

In a case where the plurality of droplet discharge heads are driven, the wind-velocity of the gas contacting the droplet discharge heads is different at each of the heads. In a case where the plurality of droplet discharge heads are arranged without being given any space therebetween, for example, there is no space where the gas flows at the center while there is a space where the gas flows around the droplet discharge heads arranged at ends. Here, the gas hardly flows at the center, so that the wind-velocity is low, while the gas easily flows at the ends, so that the wind-velocity is high. The droplet discharge heads positioned where the wind-velocity of the flowing gas is high are cooled more quickly because the heat is easily transferred to be removed than the droplet discharge heads positioned where the wind-velocity of the gas is low.

In terms of the droplet discharge heads having same heat capacity, the droplet discharge heads that are cooled quickly need energy corresponding to larger heat quantity than the droplet discharge heads that are cooled slowly need, in order to stabilize the temperature thereof.

Therefore, in terms of the plurality of droplet discharge heads, the temperature of the droplet discharge heads is easily stabilized in a case where the pressurizing part pressurizes the portion defining a cavity with a higher frequency of variation of pressure for pressurizing the portion defining a cavity when the droplet discharge heads are positioned where the wind-velocity is high, compared to a frequency when the droplet discharge heads are positioned where the wind-velocity is low. The pressurization controlling part controls the plurality of droplet discharge heads as above, so that the functional liquid can be controlled to be discharged with accurate discharge amount.

In the method for controlling a droplet discharge head of the aspect, in a case where the functional liquid is not discharged from the nozzle, a temperature of the droplet discharge head may be measured with a measurement part, and the pressurization controlling part may control the pressurizing part such that the pressurizing part pressurizes the portion defining a cavity with a high frequency of variation of pressure for pressurizing the portion defining a cavity when a temperature of the droplet discharge head is low, compared to a frequency of variation of pressure for pressurizing the portion defining a cavity when the temperature of the droplet discharge head is high.

According to the method of the aspect, the droplet discharge head includes a measurement part measuring the temperature thereof.

The temperature of some droplet discharge heads is relatively high, and the temperature in other droplet discharge heads is relatively low. The measurement part measures the temperature of the droplet discharge heads. In a case where the temperature of the droplet discharge heads is high, the portion defining a cavity is pressurized with low frequency. In a case where the temperature of the droplet discharge heads is low, the portion defining a cavity is pressurized with high frequency.

The pressurizing part can supply higher energy to the droplet discharge head in a case where the portion defining a cavity is pressurized with high frequency, compared to a case where the portion defining a cavity is pressurized with low frequency. A portion of the energy is converted into heat, so that the pressurizing part can supply higher energy to the droplet discharge head in a case where the portion defining a cavity is pressurized with high frequency, compared to a case with low frequency.

In the droplet discharge heads having low temperature, the temperature can be raised in a shorter period of time in a case where the portion defining a cavity is pressurized with high frequency than a case pressurized with low frequency. On the other hand, in the droplet discharge heads having high temperature, the portion defining a cavity is pressurized with low frequency so as to heat with small quantity of heat, being able to prevent the temperature from rising excessively. Thus, the temperature of the droplet discharge heads is easily stabilized. The pressurization controlling part controls the droplet discharge head as above, so that the functional liquid can be controlled to be discharged with accurate discharge amount.

The method for controlling a droplet discharge head of the aspect, the pressurization controlling part may control the pressurizing part such that the pressurizing part changes amplitude of pressure for pressurizing the portion defining a cavity instead of the frequency of variation of pressure for pressurizing the portion defining a cavity, so as to pressurize the portion defining a cavity.

According to the method, in a case where the functional liquid is not discharged from the nozzle, the pressurization controlling part controls the pressurizing part such that the pressurizing part changes the pressure amplitude of the pressure variation so as to pressurize the portion defining a cavity. The pressurizing part needs large amount of energy to pressurize the portion defining a cavity strongly, and needs small amount of energy to pressurize the portion defining a cavity weakly. Therefore, there is a correlative relation between the pressure amplitude of the pressure variation of pressure for pressurizing the portion defining a cavity and energy that is supplied. A portion of the energy that is supplied to the droplet discharge head is converted into heat. Therefore, the pressurizing part changes the pressure amplitude of the pressure variation so as to pressurize the portion defining a cavity, being able to supply heat to the droplet discharge head corresponding to the temperature of the droplet discharge head.

The method for controlling a droplet discharge head of the aspect, the pressurization controlling part may control the pressurizing part such that the pressurizing part changes a duty ratio of variation of pressure for pressurizing the portion defining a cavity instead of the frequency of variation of pressure for pressurizing the portion defining a cavity, so as to pressurize the portion defining a cavity.

According to the method, in a case the functional liquid is not discharged from the nozzle, the pressurization controlling part controls the pressurizing part such that the pressurizing part changes the duty ratio of the pressure variation at a plurality of steps so as to pressurize the portion defining a cavity. The pressurizing part needs large amount of energy to pressurize the portion defining a cavity for a long period of time, and needs small amount of energy to pressurize the portion defining a cavity for a short period of time. Therefore, there is a correlative relation between the duty ratio of the pressure variation for pressurizing the portion defining a cavity and energy that is supplied. A portion of the energy to be supplied to the droplet discharge head is converted into heat. Therefore, the pressurizing part changes the duty ratio of the pressure variation so as to pressurize the portion defining a cavity at the plurality of steps, being able to supply heat to the droplet discharge head corresponding to the temperature of the droplet discharge head.

### BRIEF DESCRIPTION OF THE DRAWINGS

The invention will be described with reference to the accompanying drawings, wherein like numbers reference like elements.

FIG. 1 is a schematic perspective view showing a structure of a droplet discharge device according to a first embodiment of the invention.

FIG. 2 is a schematic sectional view showing a major structure of a droplet discharge head.

FIGS. 3A and 3B are schematic view showing a flow of gas.

FIG. 4 is a block diagram showing electric control of the droplet discharge device.

FIG. 5 is a block diagram showing electric control of a head driving circuit.

FIGS. 6A to 6C are graphs for explaining a driving waveform of a droplet discharge head.

FIGS. 7A and 7B are graphs for explaining a driving waveform of a droplet discharge head.

FIG. 8 is a graph for explaining temperature change of a droplet discharge head.

FIG. 9 is a flow chart showing a process for drawing on a substrate.

FIGS. 10A and 10B are schematic views for explaining a method for drawing with the droplet discharge device.

FIGS. 11A and 11B are schematic views for explaining a method for drawing with the droplet discharge device.

FIG. 12 is a schematic sectional view showing a major structure of the droplet discharge head according to a second embodiment of the invention.

FIG. 13 is a block diagram showing electric control of the droplet discharge device.

FIG. 14 is a flow chart showing a process for warm-up driving the droplet discharge head.

FIGS. 15A to 15C are graphs for explaining a driving waveform of a droplet discharge head according to a third embodiment of the invention.

FIGS. 16A to 16C are graphs for explaining a driving waveform of a droplet discharge head according to a fourth embodiment of the invention.

### DESCRIPTION OF EXEMPLARY EMBODIMENTS

Embodiments of the present invention will now be described with reference to the accompanying drawings.

The scales of members in the drawing are adequately changed so that they can be recognized.

### First Embodiment

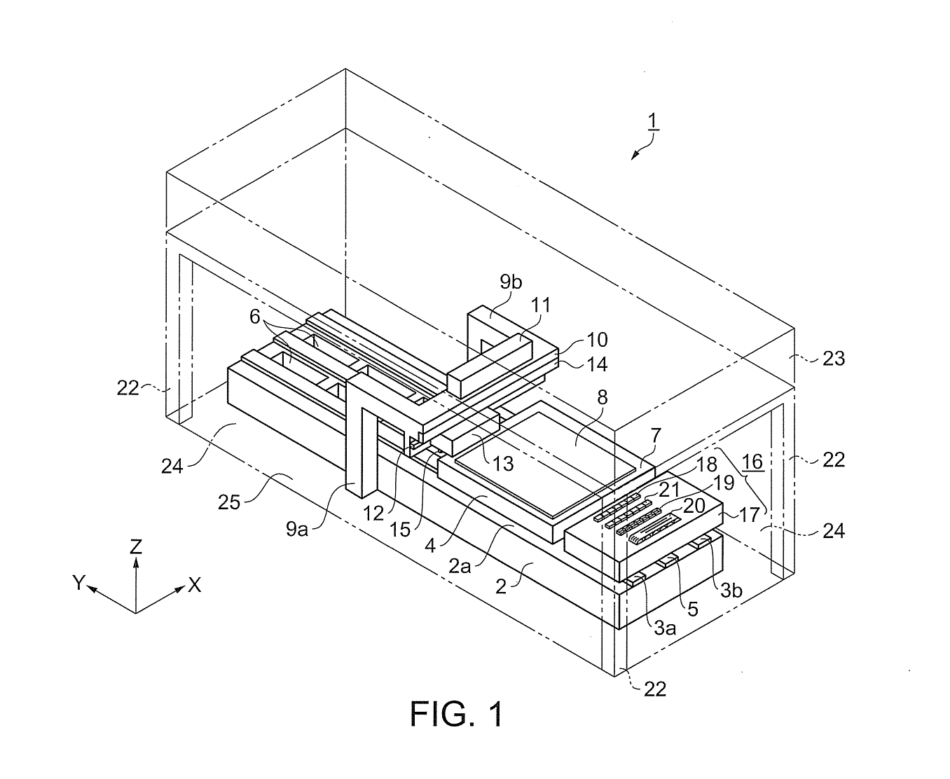

A droplet discharge device and an example discharging droplets with this droplet discharge device according to a first embodiment of the present invention will be described with reference to FIGS. 1 to 11B.

### (Droplet Discharge Device)

At first, a droplet discharge device 1 that discharges and applies droplets to a work will be described with reference to FIGS. 1 to 7B. There are various kinds of droplet discharge devices, but a device employing an ink-jet method is preferable. The ink-jet method enables fine droplet discharge, being preferable for fine processing.

FIG. 1 is a perspective view schematically showing a structure of the droplet discharge device 1. This droplet discharge device 1 discharges and applies a functional liquid.

As shown in FIG. 1, the droplet discharge device 1 includes a rectangular parallelepiped base 2. In the embodiment, a longitudinal direction of the base 2 is denoted as Y-direction and a direction perpendicular to Y-direction is denoted as X-direction.

On an upper surface 2a of the base 2, a pair of guide rails 3a, 3b is formed extending whole width of the base 2 along Y-direction in a projected manner. On the upper side of the base 2, a stage 4 as a table is attached. The stage 4 serves as a scanning means having a linear moving mechanism that is not shown and corresponds to the pair of guide rails 3a, 3b. The linear moving mechanism of the stage 4 is a screw-type linear moving mechanism including a screw shaft (a drive shaft) extending along the guide rails 3a, 3b in Y-direction and a ball nut that is screwed together with the screw shaft. The drive shaft is coupled to a Y-axis motor (not shown) that receives a predetermined pulse signal to rotate normally or reversely in units of step. If a driving signal that corresponds to a predetermined number of steps is inputted into the Y-axis motor, the Y-axis motor rotates normally or reversely so as to move the stage 4 forward or rearward along Y-axis direction (scan in Y-direction) correspondingly to the number of steps at a predetermined velocity.

In addition, on the upper surface 2a of the base 2, a main scanning position detecting device 5 is disposed in parallel to the guide rails 3a, 3b, so that a position of the stage 4 can be measured.

The base 2 is provided with vents 6 between the guide rail 3a and the main scanning position detecting device 5, and between the guide rail 3b and the main scanning position detecting device 5. Air that is at upper side of the droplet discharge device 1 passes through the vents 6 to flow toward a floor (toward reverse Z-direction of the drawing).

On the upper surface of the stage 4, a placing surface 7 is formed. The placing surface 7 includes a suction type substrate chuck mechanism that is not shown. When a substrate 8 as a work is placed on the placing surface 7, the substrate chuck mechanism positions and fixes the substrate 8 at a predetermined position of the placing surface 7.

At the both sides of the base 2 in X-direction, a pair of supporting boards 9a, 9b is provided and a guide member 10 is formed extending in X-direction in a straddling manner between the pair of supporting boards 9a, 9b.

On the upper side of the guide member 10, a storing tank 11 is provided. The storing tank 11 stores a liquid to be discharged such that the liquid can be supplied. On the other hand, on the bottom side of the guide member 10, a guide rail 12 is formed extending in whole width of the guide member 10 along X-direction in a projected manner.

A carriage 13 as a table disposed movably along the guide rail 12 is formed in approximately rectangular parallelepiped shape. A linear moving mechanism of the carriage 13 is, for example, a screw-type linear moving mechanism including a screw shaft (a drive shaft) extending along the guide rail 12 in X-direction and a ball nut to be screwed together with the screw shaft. The drive shaft is coupled to an X-axis motor (not shown) that receives a predetermined pulse signal to rotate normally or reversely in units of step. If a driving signal that corresponds to a predetermined number of steps is inputted into the X-axis motor, the X-axis motor rotates normally or reversely so as to move the carriage 13 forward or rearward along X-direction (scan in X-direction) correspondingly to the number of steps. A sub-scanning position detecting device 14 is provided between the guide member 10 and the carriage 13, so that a position of the carriage 13 can be measured. On the bottom surface of the carriage 13 (a surface facing the stage 4), a droplet discharge head 15 is provided in a projected manner.

On the upper side of the base 2 and at one side of the stage 4 (at reverse Y-direction in the drawing), a cleaning unit 16 is provided. The cleaning unit 16 includes a maintenance stage 17 that includes a flushing unit 18, a capping unit 19, a wiping unit 20, and a weight measurement device 21 thereon.

The maintenance stage 17 is positioned on the guide rails 3a, 3b and includes a same linear moving mechanism as that of the stage 4. The main scanning position detecting device 5 detects a position of the maintenance stage 17 and the linear moving mechanism moves the maintenance stage 17. Thus the maintenance stage 17 can be moved to and stopped at a desired position.

The flushing unit 18 receives droplets that are discharged from the droplet discharge head 15 when a flow channel in the droplet discharge head 15 is cleaned. In a case where a solid matter enters the droplet discharge head 15, the droplet discharge head 15 discharges droplets so as to remove the solid matter therefrom, cleaning the discharge head 15. The flushing unit 18 receives the droplets. The embodiment arranges seven saucers, so that seven droplet discharge heads 15 can discharge the droplets to the flushing unit 18.

The capping unit 19 lids the droplet discharge head 15. The droplets discharged from the droplet discharge head 15 are sometimes volatile. If a solvent of a functional liquid stored in the droplet discharge head 15 is vaporized from a nozzle, the viscosity of the functional liquid varies, causing a clog of the nozzle. The capping unit 19 lids the droplet discharge head 15 so as to prevent the nozzle from clogging.

The wiping unit 20 wipes a nozzle plate, on which the nozzle is disposed, of the droplet discharge head 15. The nozzle plate is arranged on a surface of the droplet discharge head 15 in an opposed manner to the substrate 8. If droplets are attached to the nozzle plate, the droplets attached to the nozzle plate contact the substrate 8, causing an attachment of the droplets to an unexpected place. The wiping unit 20 wipes the nozzle plate so as to prevent the droplets from attaching to an unexpected position of the substrate 8.

The weight measurement device 21 is provided with seven electronic balances that respectively include saucers. The electronic balances measure the weight of the droplets that are discharged from the droplet discharge head 15 to the saucers. The saucers include a spongelike absorber, so that the droplets are prevented from splashing and flying out of the saucers. The electronic balances measure the weight of the saucer before and after the droplet discharge head 15 discharges droplets. The electronic balances calculate weight difference of the saucer between before and after the discharge so as to measure the weight of the droplets.

The maintenance stage 17 moves along the guide rails 3a, 3b so as to dispose one of the flushing unit 18, the capping unit 19, the wiping unit 20, and the weight measurement device 21 at a place opposed to the droplet discharge head 15.

The carriage 13 moves along the guide rail 12 in X-direction and the droplet discharge head 15 moves to a place opposed to the cleaning unit 16 or the substrate 8 so as to discharge droplets.

The droplet discharge device 1 includes columns 22 at four corners thereof and an air controlling device 23 as a blowing part at an upper part (at Z-direction in the drawing) thereof. The air controlling device 23 includes a fan, a filter, an air-conditioner, a humidity regulator, and the like. The fan (blower) sucks an air in a factory and allows the air to pass through the filter so as to remove dusts within the air, supplying cleaned air.

The air-conditioner controls a temperature of the air that is to be supplied so as to maintain an atmospheric temperature of the droplet discharge device 1 within a predetermined temperature range. The humidity regulator controls humidity of the air that is to be humidified or dehumidified to be supplied, so as to maintain an atmospheric humidity of the droplet discharge device 1 within a predetermined humidity range.

Between the four columns 22, seats 24 are disposed so as to block air current. The air supplied from the air controlling device 23 flows from the air controlling device 23 toward the floor 25 (toward reverse Z-direction in the drawing), so that the dusts within a space surrounded by the seats 24 flow toward the floor 25. Thus, the dusts hardly attaches to the substrate 8.

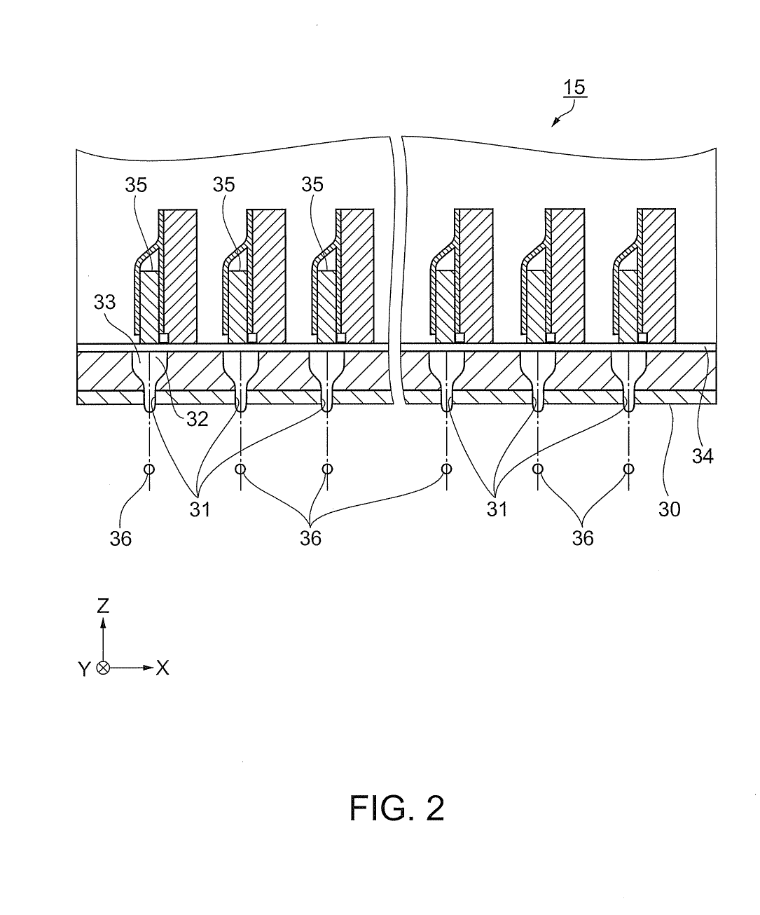

FIG. 2 is a schematic sectional view for explaining a major structure of the droplet discharge head 15.

As shown in FIG. 2, the droplet discharge head 15 includes a nozzle plate 30 that is provided with a nozzle 31. A cavity 32 communicating with the nozzle 31 is provided on the upper side of the nozzle plate 30, that is, an opposite position to the nozzle 31. To the cavity 32 of the droplet discharge head 15, a functional liquid 33 that is stored in the storing tank 11 is supplied.

On the upper side of the cavity 32, a vibration plate 34 and a piezoelectric element 35 that serves as a pressurizing part are provided. The vibration plate 34 vibrates along vertical direction (in Z-direction) to increase and decrease the volume within the cavity 32. The piezoelectric element 35 stretches and constricts along vertical direction to vibrate the vibration plate 34. The piezoelectric element 35 stretches and constricts along vertical direction to pressurize the vibration plate 34, so that the vibration plate 34 increases and decreases the volume within the cavity 32 to pressurize the cavity 32. Accordingly, the pressure within the cavity 32 varies so that the functional liquid 33 stored in the cavity 32 is discharged through the nozzle 31.

When the droplet discharge head 15 receives a nozzle driving signal for controlling and driving the piezoelectric element 35, the piezoelectric element 35 stretches so that the vibration plate 34 decreases the volume within the cavity 32. Consequently, the functional liquid 33 in equal amount to a decreased volume within the cavity 32 is discharged in fine droplets 36 from the nozzle 31 of the droplet discharge head 15.

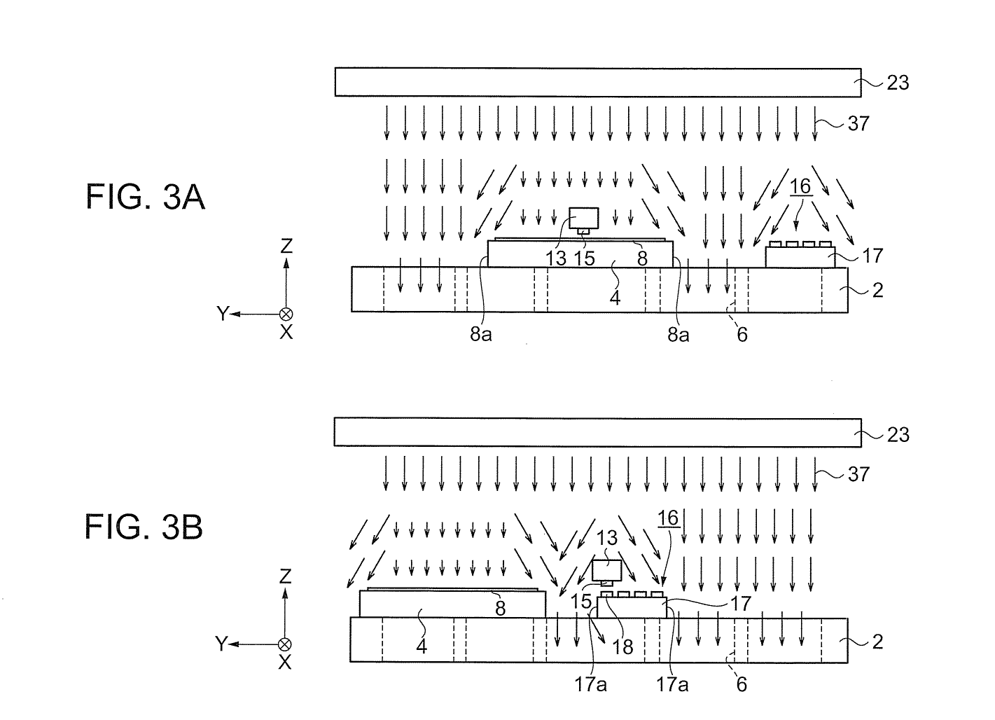

FIGS. 3A and 3B are schematic views for explaining a flow of gas within the droplet discharge device 1.

FIG. 3A shows a state that the stage 4 is positioned opposed to the droplet discharge head 15. As shown in FIG. 3A, the air controlling device 23 exhausts air so as to form an air-current 37 as a gas-current. In the figure, a direction of an arrow of the air-current 37 denotes a direction along which the air flows and a length of the arrow denotes a magnitude of the wind-velocity.

The air-current 37 heads toward the base 2 in the vicinity of the air controlling device 23. The air controlling device 23 includes a filter for removing dusts. The air controlling device 23 includes different kinds of filters. A filter above the stage 4 removes finer dusts than that above the maintenance stage 17. The air-current 37 passes through the filter that removes fine dusts more slowly than through the filter that removes rough dusts. Therefore, the wind-velocity of the air-current 37 above the stage 4 is smaller than that above the maintenance stage 17.

In a case where the droplet discharge head 15 is positioned opposed to the stage 4, the air-current 37 around the droplet discharge head 15 has small wind-velocity.

FIG. 3B shows a state that the maintenance stage 17 of the cleaning unit 16 is positioned opposed to the droplet discharge head 15. As shown in FIG. 3B, the air controlling device 23 exhausts air so as to form the air-current 37 as a gas-current.

The air-current 37 flows toward the base 2 in the vicinity of the air controlling device 23. When the air-current 37 comes near the maintenance stage 17, the air-current 37 moves to a periphery 17a of the maintenance stage 17 because the air-current 37 can not pass through the maintenance stage 17. The air controlling device 23 employs the filter that removes rough dusts above the maintenance stage 17 compared to that above the stage 4. Therefore, the wind-velocity of the air-current 37 above the maintenance stage 17 is larger than that above the stage 4.

Since the air-current 37 flows above the maintenance stage 17 without reducing its wind-velocity, the air-current 37 does not have small wind-velocity around the droplet discharge head 15. Therefore, the wind-velocity of the air-current 37 around the droplet discharge head 15 is larger when the head 15 is positioned opposed to the maintenance stage 17 than when it is positioned opposed to the stage 4.

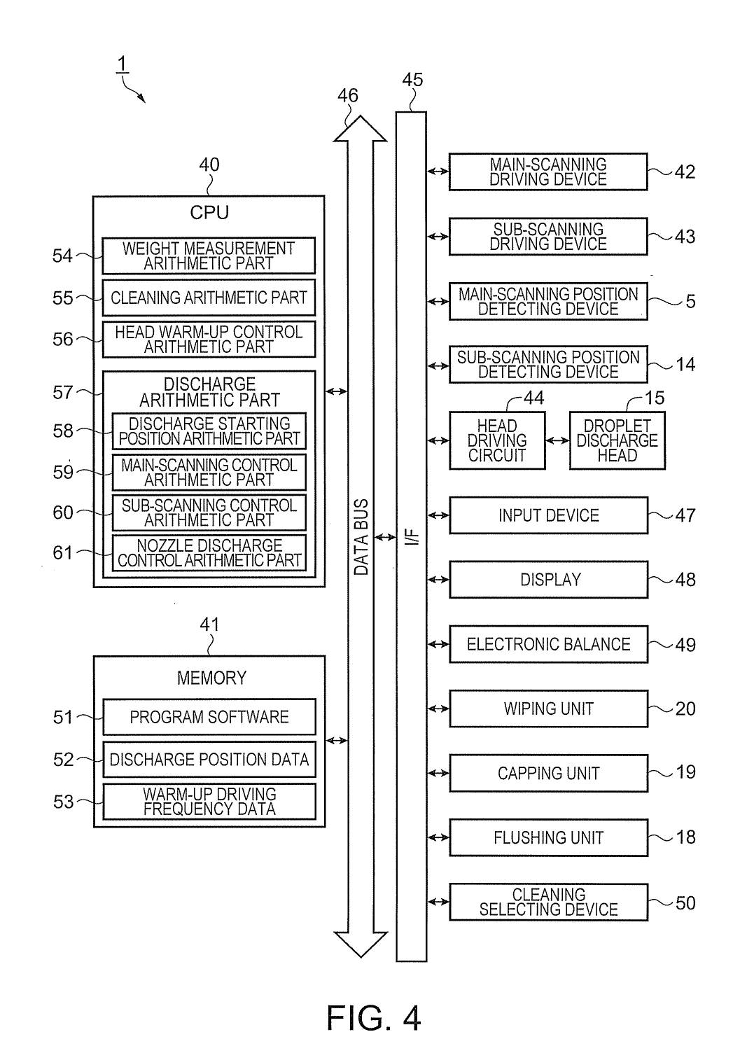

FIG. 4 is a block diagram showing electric control of the droplet discharge device. Referring to FIG. 4, the droplet discharge device 1 includes a central processing unit (CPU) that executes various processing as a processor, and a memory 41 that stores various information.

A main-scanning driving device 42, a sub-scanning driving device 43, a main-scanning position detecting device 5, a sub-scanning position detecting device 14, and a head driving circuit 44 that drives the droplet discharge head 15 are coupled through an input/output interface 45 and a data bus 46 to the CPU 40. In addition, an input device 47, a display 48, an electronic balance 49 that is provided to the weight measurement device 21 shown in FIG. 1, the flushing unit 18, the capping unit 19, and the wiping unit 20 are also coupled through the input/output interface 45 and the data bus 46 to the CPU 40. Further, a cleaning selecting device 50 that selects one unit among the electronic balance 49, the flushing unit 18, the capping unit 19, and the wiping unit 20 is coupled through the input/output interface and the data bus 46 to the CPU 40.

The main-scanning driving device 42 controls a move of the stage 4, and the sub-scanning driving device 43 controls a move of the carriage 13. The main-scanning position detecting device 5 recognizes a position of the stage 4 and the sub-scanning driving device 42 controls the move of the stage 4, so that the stage 4 can be moved to and stopped at a desired position. In the same manner, the sub-scanning position detecting device 14 recognizes a position of the stage 13 and the sub-scanning driving device 43 controls the move of the stage 13, so that the stage 13 can be moved to and stopped at a desired position.

The input device 47 inputs various processing conditions for discharging droplets. For example, the input device 47 receives and inputs coordinates for discharging droplets to the substrate 8 from an external device not shown. The display 48 displays processing conditions and operating states. Operators execute operations with the input device 47 based on information displayed on the display 48.

The electronic balance 49 measures the weight of the saucer that receives droplets discharged from the droplet discharge head 15. The electronic balance 49 measures the weight of the saucer before and after the droplet discharge so as to send measured values to the CPU 40. The weight measurement device 21 shown in FIG. 1 is composed of the saucer, the electronic balance 49, and the like.

The cleaning selecting device 50 selects one device among the flushing unit 18, the capping unit 19, the wiping unit 20, and the weight measurement device 21 so as to move the maintenance stage 17 such that the selected device is positioned opposed to the droplet discharge head 15.

The memory 41 may be semiconductor memories such as RAM and ROM; hard disks; and external memory devices such as CD-ROM. The memory 41, in terms of its function, has a storage area storing a program software 51 in which a controlling procedure of operations in the droplet discharge device 1 is described. In addition, the memory 41 has a storage area for storing a discharge position data 52 that is a coordinate data of the discharge position on the substrate 8. Further, the memory 41 has a warm-up driving frequency data 53 that is a relational data between a position of the droplet discharge head 15 and a driving frequency in warm-up driving of the droplet discharge head 15. Furthermore, the memory 41 has a storage area for storing a main-scanning moving amount of the substrate 8 moved in the main-scanning direction (Y-direction) and a sub-scanning moving amount of the carriage 13 moved in the sub-scanning direction (X-direction), a storage area serving as a work area or a temporary file for the CPU 40, and other various storage areas.

The CPU 40 performs control for discharging the functional liquid in droplets to a predetermined position on the surface of the substrate 8 in accordance with the program software 51 that is stored in the memory 41. The CPU 40 includes, as a specific function realization part, a weight measurement arithmetic part 54 calculating for realizing the weight measurement with the electronic balance 49. Further, the CPU 40 includes a cleaning arithmetic part 55 that calculates timing of cleaning of the droplet discharge head 15, and a head warm-up control arithmetic part 56 as a pressurization controlling part that calculates a driving frequency for warm-up driving of the droplet discharge head 15. Furthermore, the CPU 40 includes a discharge arithmetic part 57 that calculates for discharging droplets with the droplet discharge head 15.

Particularly, the discharge arithmetic part 57 includes a discharge starting position arithmetic part 58 for setting the droplet discharge head 15 at a starting position for the droplet discharge. Further, the discharge computing part 57 includes a main-scanning control arithmetic part 59 that operates a control for moving and scanning the substrate 8 along the main-scanning direction (Y-direction) at a predetermined velocity. In addition, the discharge arithmetic part 57 includes a sub-scanning control arithmetic part 60 that operates a control for moving the droplet discharge head 15 along the sub-scanning direction (X-direction) in a predetermined sub-scanning amount. Further, the discharge arithmetic part 57 includes various kinds of function arithmetic parts such as a nozzle discharge control arithmetic part 61 that calculates for controlling which nozzle is operated to discharge the functional liquid among the plurality of nozzles of the droplet discharge head 15.

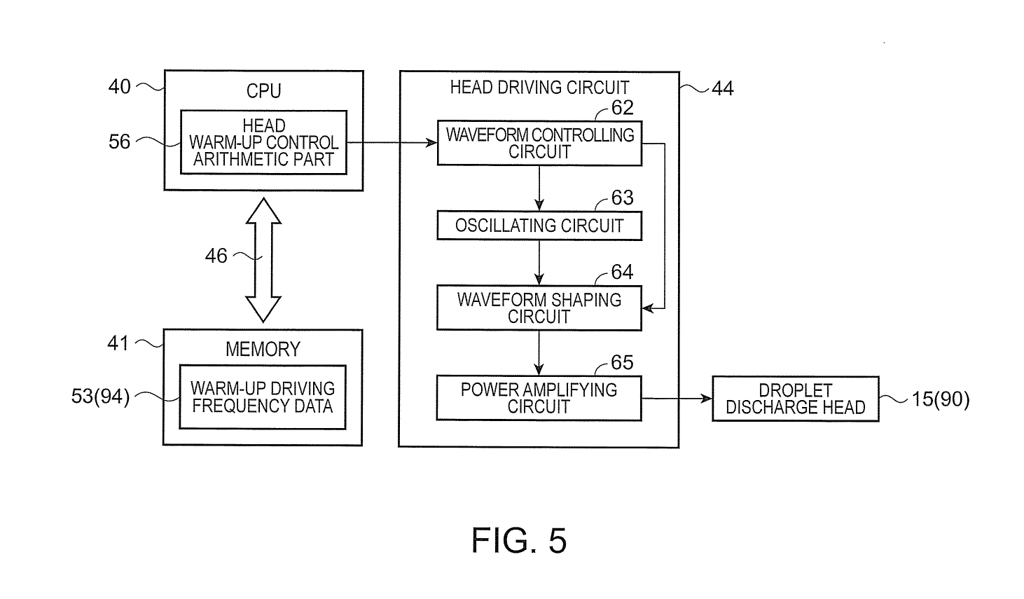

FIG. 5 is a block diagram showing electric control of the head driving circuit 44. As shown in FIG. 5, the head driving circuit 44 includes a waveform controlling circuit 62, an oscillating circuit 63, a waveform shaping circuit 64, and a power amplifying circuit 65. The waveform controlling circuit 62 serves as an interface with respect to the CPU 40. The waveform controlling circuit 62 decodes a signal received from the CPU 40 to control other circuits in combination.

The oscillating circuit 63 oscillates at a frequency that is indicated by the waveform controlling circuit 62 to form a pulse waveform. The waveform shaping circuit 64 shapes a waveform that is indicated by the waveform controlling circuit 62 in synchronization with the pulse waveform outputted from the oscillating circuit 63. The power amplifying circuit 65 amplifies the electric power of the waveform outputted from the waveform shaping circuit 64 so as to output an electric current capable of driving the droplet discharge head 15.

For warm-up driving the droplet discharge head 15, the CPU 40 first detects a state of a position opposed to the droplet discharge head 15 based on the output of the main-scanning position detecting device 5. In particular, the CPU 40 detects whether the position opposed to the droplet discharge head 15 is occupied by the stage 4 or the cleaning unit 16 or the position is vacancy. Subsequently, the head warm-up control arithmetic part 56 refers to the warm-up driving frequency data 53 to calculate a driving frequency for driving the droplet discharge head 15 in the above state and then outputs data of the driving frequency and a waveform condition of the warm-up drive to the waveform controlling circuit 62.

For discharge-driving the droplet discharge head 15, the CPU 40 outputs the data of the driving frequency for discharging and the waveform condition for warm-up driving to the waveform controlling circuit 62.

The waveform controlling circuit 62 receives the data of the driving frequency to output an indication signal for oscillating at a driving frequency indicated by the waveform controlling circuit 62 to the oscillating circuit 63. Then the waveform controlling circuit 62 outputs the waveform shaping data to the waveform shaping circuit 64. The waveform shaping data relates to waveform shapes such as a pulse width of the waveform, the rise time, the fall time, and the like.

The oscillating circuit 63 receives the driving frequency and the oscillating indication signal to oscillate at the indicated driving frequency, thereby outputting a pulse signal to the waveform shaping circuit 64. The waveform shaping circuit 64 receives the pulse signal from the oscillating circuit 63 and the waveform shaping data from the waveform controlling circuit 62. Subsequently, the waveform shaping circuit 64 produces a waveform signal that is indicated by the waveform shaping data so as to output a driving waveform synchronized with the pulse signal to the power amplifying circuit 65.

The power amplifying circuit 65 receives the driving waveform to amplify the electric power. Then the power amplifying circuit 65 outputs an electric current capable of driving the piezoelectric element 35 of the droplet discharge head 15 to the droplet discharge head 15.

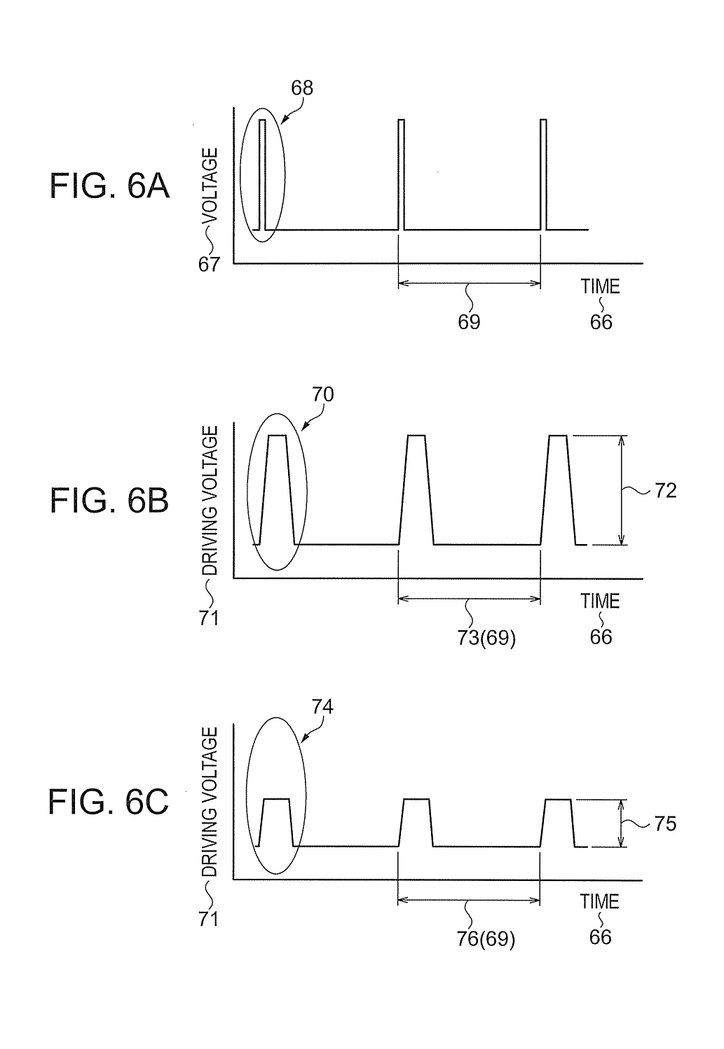

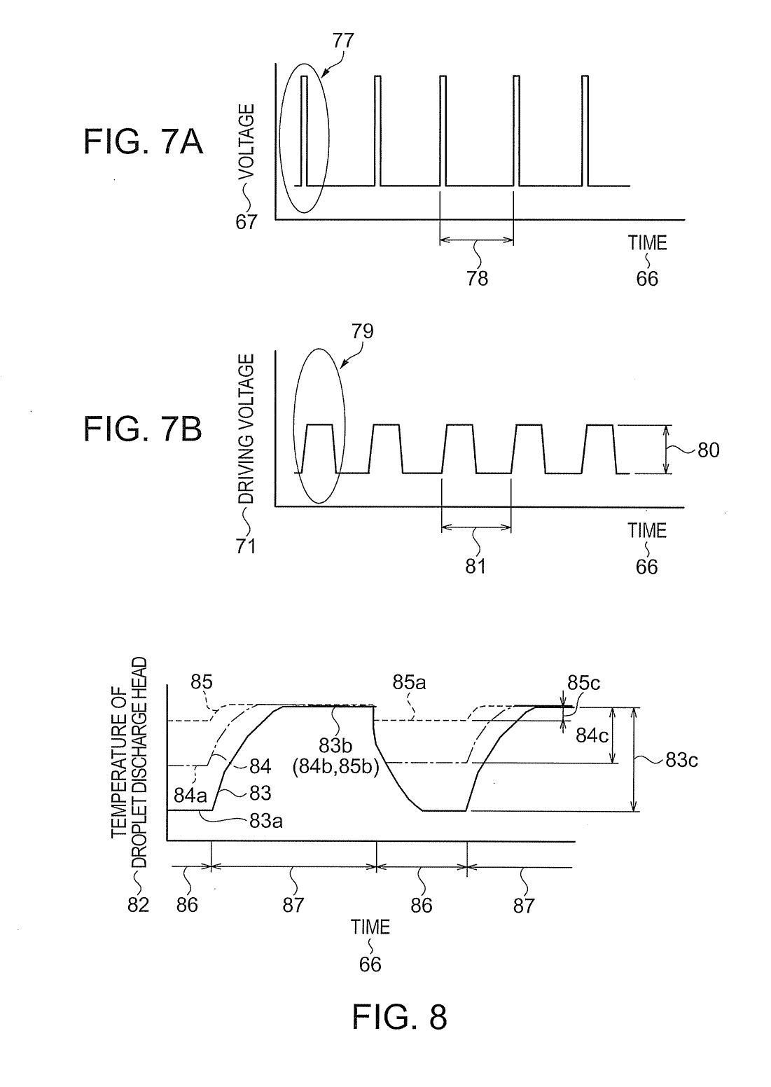

FIGS. 6A to 7B are graphs for explaining a driving waveform of the droplet discharge head. FIG. 6A shows a waveform of the pulse signal outputted from the oscillating circuit 63. The horizontal axis of the graph denotes passage of time 66 and the vertical axis denotes change of voltage 67. As shown in the drawing, a first waveform 68 of the pulse signal outputted from the oscillating circuit 63 is a rectangular waveform. A time interval between the first waveforms 68 is a first period 69 that corresponds to the frequency indicated by the CPU 40. The first period 69 is set such that the piezoelectric element 35 can vibrate to continuously discharge the fine droplets 36.

FIG. 6B shows three discharge driving waveforms 70 that are an example in a case where the fine droplets 36 are continuously discharged from the droplet discharge head 15. The horizontal axis of the graph denotes passage of time 66 and the vertical axis denotes change of driving voltage 71. The discharge driving waveform 70 is in approximate trapezoid shape. A discharge voltage 72 that is a peak value of the driving voltage on discharging is set to be a predetermined voltage. A discharge waveform period 73 that is an interval between the discharge driving waveforms 70 has the same time interval as the first period 69 between the first waveforms 68 of the pulse signal. The discharge voltage 72 and the first period 69 need to be set in accordance with characteristics of the piezoelectric element 35 and the vibration plate 34. Therefore, it is preferable that a preliminary test in which the discharge is actually carried out be executed to derive a most suitable discharge condition.

FIG. 6C shows three first non-discharge driving waveforms 74 that are an example on driving the droplet discharge head 15 without discharging the fine droplets 36 from the droplet discharge head 15, that is, on warm-up driving. The first non-discharge driving waveform 74 is in approximate trapezoid shape. It is preferable that first non-discharge driving voltage 75, which is a peak value of the driving voltage in non-discharge, largely vibrate the piezoelectric element 35 at an extent not discharging the fine droplets 36. In the embodiment, the first non-discharge voltage 75 is, for example, a voltage that is approximately one third of a discharge voltage 63. Further, a first non-discharge waveform period 76 that is an interval between the first non-discharge driving waveforms 74 may be within a range where the piezoelectric element 35 vibrates. The first non-discharge waveform period 76 has the same time interval as the first period 69 between the first waveforms 68 of the pulse signal in the same manner as the discharge waveform period 73.

FIG. 7A is a graph showing an example of a waveform of the pulse signal outputted from the oscillating circuit 63 when the fine droplets 36 are not discharged from the droplet discharge head 15. The horizontal axis of the graph denotes passage of time 66 and the vertical axis denotes change of voltage 67. As shown in the drawing, a second waveform 77 of the pulse signal outputted from the oscillating circuit 63 is a rectangular waveform in a second period 78 that corresponds to a frequency indicated by the CPU 40.

The second period 78 that is an interval between the second waveforms 77 of the pulse signal is a range where the piezoelectric element 35 vibrates. The second period 78 is set such that the piezoelectric element 35 can vibrate in a shorter interval than the interval between the first waveforms 68 of the pulse signal. The second period 78 has, for example, a half time interval of the first period 69 between the first waveforms 68 of the pulse signal in the embodiment.

FIG. 7B shows five second non-discharge driving waveforms 79 that are an example in a case where the fine droplets 36 are not discharged from the droplet discharge head 15. The second non-discharge driving waveform 79 is in approximate trapezoid shape. It is preferable that second non-discharge driving voltage 80, which is a peak value of the driving voltage in non-discharge, largely vibrate the piezoelectric element 35 at an extent not discharging the fine droplets 36. In the embodiment, the second non-discharge voltage 80 is, for example, a voltage that is approximately one third of the discharge voltage 63. In addition, a second non-discharge waveform period 81 that is an interval between the second non-discharge driving waveforms 79 has the same time interval as the second period 78.

FIG. 8 is a graph for explaining temperature change of the droplet discharge head 15. In FIG. 8, the horizontal axis of the graph denotes passage of time 66 and the vertical axis denotes change of a temperature 82 of the droplet discharge head. A solid line denotes a non-vibration time temperature change line 83 on which the droplet discharge head 15 is not warm-up driven when the fine droplets 36 are not discharged from the droplet discharge head 15.

A first vibration time temperature change line 84 denoted by a dashed-dotted line shows temperature change of the droplet discharge head 15 positioned where the air current 37 having large wind-velocity contacts the droplet discharge head 15. The first vibration time temperature change line 84 shows the temperature change of the droplet discharge head 15 on being warm-up driven with the first non-discharge driving waveform 74 in a case where the fine droplets 36 are not discharged from the droplet discharge head 15.

In the same manner, a second vibration time temperature change line 85 denoted by a dashed line shows temperature change of the droplet discharge head 15 positioned where the air current 37 having large wind-velocity contacts the droplet discharge head 15. The second vibration time temperature change line 85 shows the temperature change of the droplet discharge head 15 on being warm-up driven with the second non-discharge driving waveform 79 in a case where the fine droplets 36 are not discharged from the droplet discharge head 15.

In terms of the horizontal axis, the non-vibration time temperature change line 83, the first vibration time temperature change line 84, and the second vibration time temperature change line 85 show the change of the temperature 82 of the droplet discharge head in a case where the droplet discharge head 15 repeats non-discharge time 86 and discharge time 87. In the non-discharge time 86, the fine droplets 36 are not discharged from the nozzle 31. In the discharge time 87, the fine droplets 36 are discharged.

The non-vibration time temperature change line 83 shows that the temperature 82 of the droplet discharge head falls down to the lowest temperature 83a in the non-discharge time 86 and rises up to the highest temperature 83b in the discharge time 87. The difference between the highest temperature 83b and the lowest temperature 83a is a temperature difference 83c. In the same manner, the first vibration time temperature change line 84 shows that the temperature 82 of the droplet discharge head falls down to the lowest temperature 84a in the non-discharge time 86 and rises up to the highest temperature 84b in the discharge time 87. The difference between the highest temperature 84b and the lowest temperature 84a is a temperature difference 84c. In the same manner as well, the second vibration time temperature change line 85 shows that the temperature 82 the droplet discharge head falls down to the lowest temperature 85a in the non-discharge time 86 and rises up to the highest temperature 85b in the discharge time 87. The difference between the highest temperature 85b and the lowest temperature 85a is a temperature difference 85c.

When the non-vibration time temperature change line 83 is compared to the first vibration time temperature change line 84, the highest temperature 83b is approximately same as the highest temperature 84b. On the other hand, the lowest temperature 83a is lower than the lowest temperature 84a. In terms of the non-vibration time temperature change line 83, since the piezoelectric element 35 is not vibrated in the non-discharge time 86, the temperature 82 of the droplet discharge head falls. In terms of the first vibration time temperature change line 84, since the piezoelectric element 35 is vibrated in the non-discharge time 86, the temperature 82 of the droplet discharge head does not easily fall due to the effect of heat generation of the piezoelectric element 35. Therefore, the temperature difference 84c of the first vibration time temperature change line 84 is smaller than the temperature difference 83c of the non-vibration time temperature change line 83.

When the first vibration time temperature change line 84 is compared to the second vibration time temperature change line 85, the highest temperature 84b is approximately same as the highest temperature 85b. On the other hand, the lowest temperature 84a is lower than the lowest temperature 85a. In terms of the first vibration time temperature change line 84, since the piezoelectric element 35 is vibrated with low frequency in the non-discharge time 86, the temperature 82 of the droplet discharge head falls. In terms of the second vibration time temperature change line 85, since the piezoelectric element 35 is vibrated with high frequency in the non-discharge time 86, the temperature 82 of the droplet discharge head hardly falls due to the large effect of heat generation of the piezoelectric element 35. Therefore, the temperature difference 85c of the second vibration time temperature change line 85 is smaller than the temperature difference 84c of the first vibration time temperature change line 84.

At a place where the air-current 37 having small wind velocity contacts the droplet discharge head 15, the droplet discharge head 15 is hardly cooled. At this time, the temperature change of the droplet discharge head 15 is similar to that of the second vibration time temperature change line 85 even in a case where the piezoelectric element 35 is vibrated with the first non-discharge driving waveform 74 to warm-up drive the droplet discharge head 15, as well. In particular, the droplet discharge head 15 is preferably vibrated with high frequency at a place where the wind-velocity of the air-current 37 is large, and the droplet discharge head 15 may be vibrated with low frequency at a place where the wind-velocity of the air-current 37 is small. It is preferable that the frequency for vibrating the droplet discharge head 15 be changed corresponding to the air-current 37 that contacts the droplet discharge head 15.

### Drawing Method

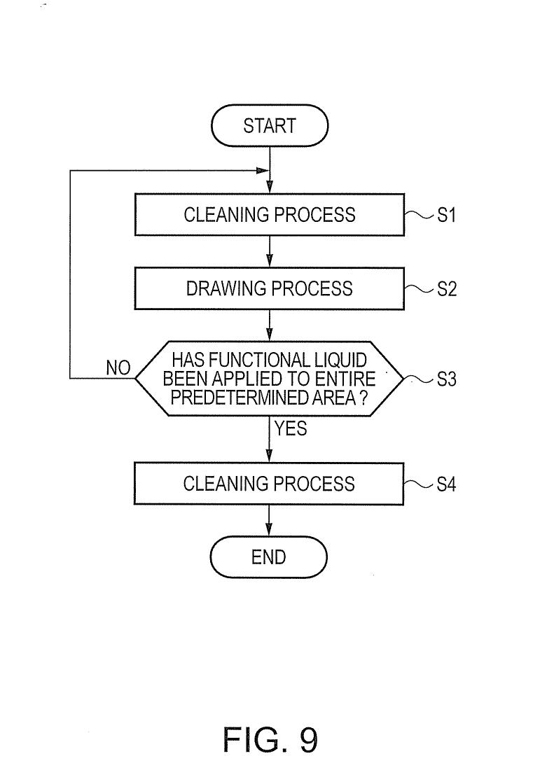

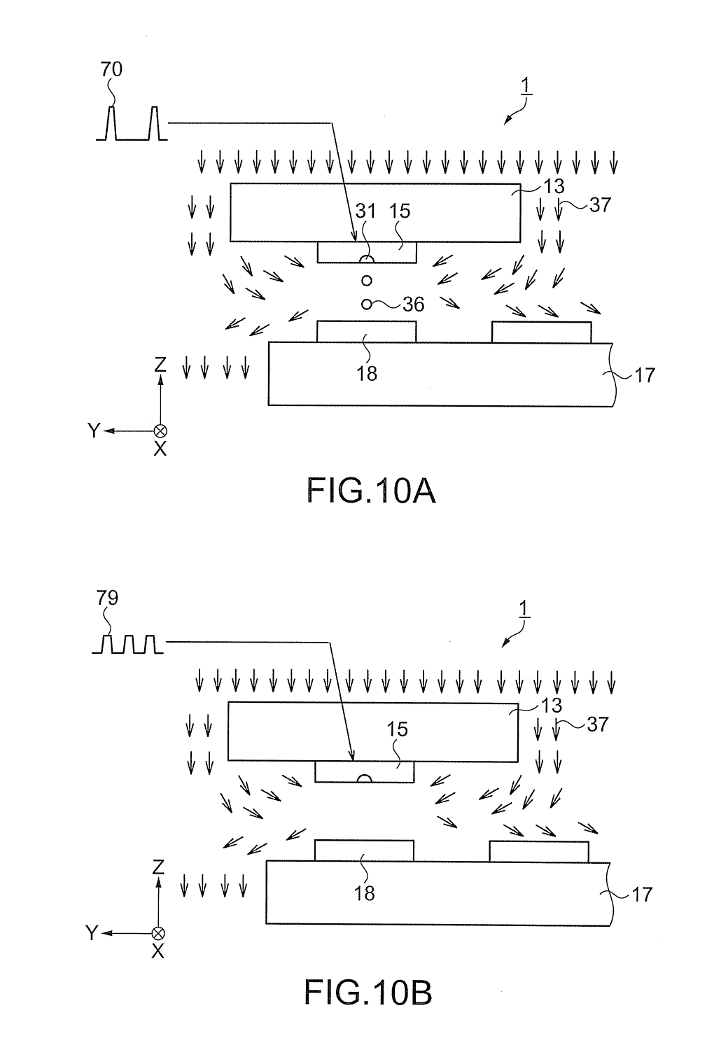

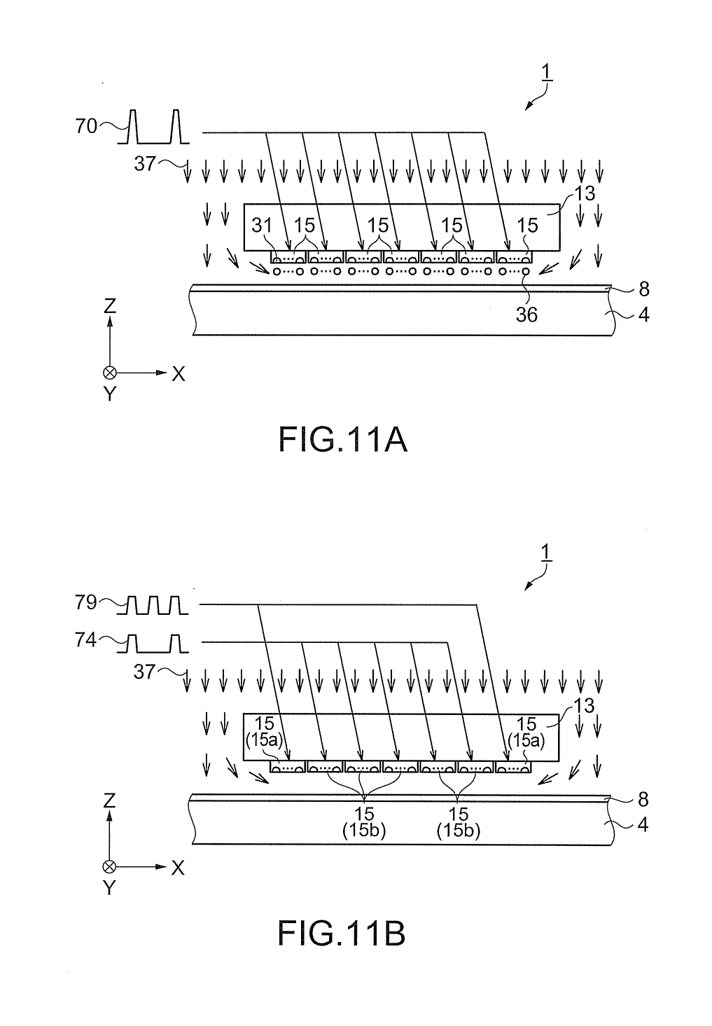

A method for drawing on the substrate 8 with the droplet discharge device 1 described above will now be described with reference to FIGS. 3A, 3B, and 9 to 11B. FIG. 9 is a flow chart showing a process for drawing on a substrate. FIGS. 10A to 11B are schematic views for explaining a method for drawing with the droplet discharge device.

The process for drawing on a substrate will be described with reference to the flow chart in FIG. 9.

In FIG. 9, steps S1 to S4 are steps of drawing with the droplet discharge device 1. The step S1 corresponds to a cleaning step that is one of maintenance steps. In the step S1, the functional liquid is discharged from the nozzle to the flushing unit to clean the droplet discharge head. The process goes to the step S2. The step S2 corresponds to a drawing step in which the functional liquid is discharged in fine droplets from the nozzle so as to be applied on the substrate. In this step, the functional liquid is applied in a predetermined area in one step. The process goes to the step S3. The step S3 corresponds to a step to judge whether the functional liquid is applied to entire predetermined area. In the step S3, the CPU compares an area where the functional liquid is to be applied with an area where the functional liquid has been already applied, so as to judge whether there is any parts where the functional liquid has not been applied in the area where the functional liquid is to be applied. In a case where there is a part where the functional liquid has not been applied (in a case of “NO”), the process returns to the step S1. In the step S3, in a case where there is no area where the functional liquid has not been applied (in a case of “YES”), the process goes to the step S4. The step S4 corresponds to a cleaning process in which the functional liquid is discharged from the nozzle to the flushing unit to clean the droplet discharge head. By performing the above steps, the process for drawing on a substrate is completed.

Here, the process for drawing will be described in detail in a corresponding manner to the steps of FIG. 9 with reference to FIGS. 3A, 3B, and 10A to 11B.

FIGS. 10A and 10B correspond to the steps S1 and S4. As shown in FIG. 10A, the maintenance stage 17 is moved in Y-direction such that the flushing unit 18 is positioned opposed to the droplet discharge head 15. Then the carriage 13 is moved in X-direction such that the droplet discharge head 15 faces the flushing unit 18.

After the droplet discharge head 15 is positioned opposed to the flushing unit 18, the fine droplets 36 are discharged from the nozzle 31 of the droplet discharge head 15 to the flushing unit 18. The discharge of the fine droplets 36 shifts a functional liquid 33 within the droplet discharge head 15. In a case where there is solid matter in a flow channel of the droplet discharge head 15, the droplet discharge head 15 discharges the solid matter together with the functional liquid 33 so as to clean the flow channel.

At this time, the discharge driving waveform 70 is inputted into the droplet discharge head 15. The droplet discharge head 15 pressurizes the cavity 32 to be heated, increasing its temperature.

As shown in FIG. 3B, the air-current 37 easily flows around the cleaning unit 16, so that the flow-velocity thereof is higher than that around the stage 4.

FIG. 10B shows a state that the droplet discharge head 15 stops discharging the fine droplets 36 to the flushing unit 18. After the droplet discharge head 15 finishes the cleaning of the flow channel, the droplet discharge head 15 waits until the next action. At this time, the second non-discharge driving waveform 79 is inputted into the droplet discharge head 15 corresponding to high flow-velocity of the air-current 37 at the periphery of the droplet discharge head 15. The droplet discharge head 15 pressurizes the cavity 32 at an extent not discharging the fine droplets 36 so as to be heated, preventing decrease of the temperature.

FIGS. 11A and 11B correspond to the step S2. As shown in FIG. 11A, the stage 4 is moved in Y-direction such that the stage 4 is positioned opposed to the droplet discharge head 15. On the stage 4, the substrate 8 is placed and fixed. Then the carriage 13 is moved in X-direction such that the droplet discharge head 15 faces an area where the functional liquid 33 is to be applied on the substrate 8.

When the nozzle 31 is positioned opposed to a place where the functional liquid 33 is to be applied, the droplet discharge head 15 is driven by a signal of the discharge driving waveform 70 so as to discharge the fine droplets 36. The droplet discharge device 1 repeatedly carries out the discharge of the fine droplets 36 and the move of the stage 4 and the carriage 13 so as to draw a desired pattern.

FIG. 11B shows a state that the droplet discharge head 15 stops discharging the fine droplets 36 to the substrate 8 and is warm-up driven. This state corresponds to the case where the droplet discharge head 15 waits until the next action. The state can also be a case where the droplet discharge head 15 waits while the stage 4 conveys the substrate 8 and the carriage 13 conveys the droplet discharge head 15 to the position where the droplet discharge head 15 next discharges the fine droplets 36.

The carriage 13 is provided with seven droplet discharge heads 15 arranged in a row. When the air-current 37 passes through the periphery of the carriage 13 to the periphery of the droplet discharge heads 15, the air-current 37 flows to contact the droplet discharge heads 15a that are placed at both ends of the row of the droplet discharge heads 15. On the other hand, the air-current 37 hardly contacts droplet discharge heads 15b that are positioned at the center in the row. Namely, the droplet discharge heads 15a are positioned where the wind-velocity is high and the droplet discharge heads 15b are positioned where the wind-velocity is low.

Since the droplet discharge heads 15a are positioned where the wind velocity is high, the heat of the droplet discharge heads 15a is easily drawn by the air-current 37. On the other hand, since the droplet discharge heads 15b are positioned where the wind velocity is low, the heat of the droplet discharge heads 15a is not easily drawn by the air-current 37.

The second non-discharge driving waveform 79 having high frequency is inputted into the droplet discharge heads 15a correspondingly to high flow velocity of the air-current 37 at the periphery of the droplet discharge heads 15a. The first non-discharge driving waveform 74 having low frequency is inputted into the droplet discharge heads 15b correspondingly to low flow-velocity of the air-current 37 at the periphery of the droplet discharge heads 15b. The droplet discharge heads 15a and the droplet discharge heads 15b pressurize the cavity 32 at an extent not discharging the fine droplets 36 so as to be heated, preventing decrease of the temperature.

Namely, since the heat of the droplet discharge heads 15a is more easily drawn than that of the droplet discharge heads 15b, the droplet discharge heads 15a are warm-up driven with high frequency to increase the amount of heat to be supplied. In the same manner, since the heat of the droplet discharge head 15 used in the cleaning process is more easily drawn than that of the droplet discharge heads 15b used in the drawing process, the droplet discharge head 15 of the cleaning process is driven with high frequency to increase the amount of heat to be supplied.

As described above, the functional liquid 33 is applied to the entire predetermined area, where the functional liquid 33 is to be applied, of the substrate 8. Thus, the drawing process is completed.

According to the embodiment described above, the following advantageous effects are provided.

(1) According to the embodiment, the piezoelectric element 35 is warm-up driven while pressurizing the cavity 32 plurality of times in succession at an extent not discharging the functional liquid 33 from the nozzle so as to change the pressure on the functional liquid 33.

The viscosity of the functional liquid 33 varies in accordance with the change of its temperature. When the functional liquid 33 passes through the flow channel such as the nozzle 31 while being pressurized in the droplet discharge head 15, the fluid resistance thereof varies, changing the discharge amount of the functional liquid 33 that is discharged from the nozzle 31. Therefore, in a case where the functional liquid 33 is discharged under small temperature change, the functional liquid 33 can be controlled to be discharged with accurate discharge amount, compared to a case under large temperature change.

In a case where the piezoelectric element 35 is not warm-up driven, the droplet discharge head 15 releases its heat to be cooled. On the other hand, in a case where the piezoelectric element 35 is warm-up driven at an extent not discharging the functional liquid 33, a portion of the energy generated in pressurizing by the piezoelectric element 35 is converted into heat. Thus the droplet discharge head 15 generates the heat. The temperature of the droplet discharge head 15 that generates the heat does not easily decrease.

In a case where the functional liquid 33 is not discharged from the nozzle 31, the piezoelectric element 35 pressurizes the cavity 32 plurality of times in succession at an extent not discharging the functional liquid 33 from the nozzle 31 so as to change the pressure on the functional liquid 33. The piezoelectric element 35 changes the frequency of the pressure variation in terms of pressure for pressurizing the cavity 32.

When the piezoelectric element 35 pressurizes the cavity 32, the frequency of the pressure variation is changed so as to be able to change the energy that the piezoelectric element 35 gives to the droplet discharge head 15. In a case where the amount of energy that is given to the droplet discharge head 15 by the piezoelectric element 35 is changed at several stages, energy that approximates the energy corresponding to the heat amount released by the droplet discharge head 15 is supplied, thus easily stabilizing the temperature of the droplet discharge head 15.

On the other hand, in a case where the functional liquid 33 is not discharged from the nozzle 31 and there is single kind of amount of energy that is given to the droplet discharge head 15 by the piezoelectric element 35, predetermined amount of energy is supplied to the droplet discharge head 15. At this time, the amount of energy that is released by the droplet discharge head 15 is sometimes different from the amount of energy that is supplied to the droplet discharge head 15. In this case, the piezoelectric element 35 is driven until the temperature of the droplet discharge head 15 reaches the desired temperature to supply energy to the droplet discharge head 15. Here, in order to prevent the temperature of the droplet discharge head 15 from rising excessively, the piezoelectric element 35 is stopped at the desired temperature of the droplet discharge head 15 so as to stop supplying the energy. Due to this stop of the energy supply, the droplet discharge head 15 releases the heat to decrease the temperature thereof. When the temperature falls down to the predetermined temperature, the energy supply starts again. Namely, the frequency that the energy supply and the supply stop are repeated increases, fluctuating the temperature of the droplet discharge head 15.

Therefore, in the case where the amount of energy that is given to the cavity 32 by the piezoelectric element 35 is changed corresponding to the temperature of the droplet discharge head 15, the temperature of the droplet discharge head 15 can be more easily stabilized than the case where there is only single kind of amount of energy that is given to the cavity 32 by the piezoelectric element 35. Consequently, the functional liquid 33 can be controlled to be discharged with accurate discharge amount.

(2) According to the embodiment, the droplet discharge device 1 includes the air conditioner 23 by which the air-current 37 is formed. Due to the air-current 37 in the droplet discharge device 1, heat generated by the droplet discharge device 1 is transferred to be removed. In a case where the droplet discharge head 15 is positioned where the wind velocity is high, the heat generated by the droplet discharge device 1 is removed and cooled more quickly than in a case where the droplet discharge head 15 is positioned where the wind velocity is low.

In terms of the droplet discharge heads 15 having same heat capacity, the droplet discharge head 15 that is cooled quickly needs energy corresponding to larger heat quantity, compared to the droplet discharge head 15 that is cooled slowly, in order to stabilize the temperature thereof.

The piezoelectric element 35 can supply larger energy in a case where the frequency of the variation of pressure for pressurizing the cavity 32 is made high, compared to a case where the frequency is low. Since a portion of the energy that is supplied is converted into heat, the piezoelectric element 35 can supply large amount of heat to the droplet discharge head 15 in a case where the frequency of the variation of pressure for pressurizing the cavity 32 is high.

Therefore, in a case where the droplet discharge head 15 is positioned where the wind-velocity is high, the frequency of the variation of pressure for pressurizing the cavity 32 is made high so as to more easily stabilize the temperature of the droplet discharge head 15, compared to the frequency in a case where it is positioned where the wind-velocity is low. Consequently, the functional liquid 33 can be controlled to be discharged with accurate discharge amount.

(3) According to the embodiment, the droplet discharge device 1 includes the plurality of droplet discharge heads 15. The wind velocity of the air-current 37 is not even in the droplet discharge device 1 such that the wind velocity of the air-current 37 is high some places and it is low in other places in the device 1. As shown in FIG. 11B, when the droplet discharge heads 15 are positioned opposed to the stage 4, the droplet discharge heads 15a are positioned where the wind-velocity of the air-current 37 is high and the droplet discharge heads 15b are positioned where the wind-velocity of the air-current 37 is low. The droplet discharge heads 15a positioned where the wind-velocity of the air-current is high are cooled more quickly than the droplet discharge heads 15b positioned where the wind-velocity of the air-current is low because the heat of the droplet discharge heads 15a is easily transferred to be removed.

In terms of the droplet discharge heads 15 having same heat capacity, the droplet discharge head 15 that is cooled quickly needs energy corresponding to larger heat quantity, compared to the droplet discharge head 15 that is cooled slowly, in order to stabilize the temperature thereof.

Therefore, in terms of the plurality of droplet discharge heads 15, the piezoelectric element 35 of the droplet discharge heads 15a positioned where the wind velocity is high more easily stabilizes the temperature thereof with higher frequency of variation of pressure for pressurizing the cavity 32, compared to the element 35 of the droplet discharge heads 15b positioned where the wind velocity is low. Consequently, the functional liquid 33 can be controlled to be discharged with accurate discharge amount.

(4) According to the embodiment, the method for drawing includes the drawing step and the cleaning step. In the drawing step, the fine droplets 36 are discharged to the substrate 8 to draw. In the cleaning step, the fine droplets 36 are discharged to the flushing unit 18 so as to shift the functional liquid 33 within the droplet discharge head 15. Further, in a case where there is solid matter in the flow channel of the droplet discharge head 15, the droplet discharge head 15 discharges the solid matter together with the functional liquid 33 so as to clean the flow channel.

The substrate 8 is positioned opposed to the droplet discharge head 15 in the drawing step, and the flushing unit 18 is positioned opposed to the droplet discharge head 15 in the cleaning step. In the drawing step and the cleaning step, there is the air-current 37 at the periphery of the droplet discharge head 15. An object opposed to the droplet discharge head 15 in the drawing step is different from an object opposed to it in the cleaning step, so that the fluid resistance of the air-current 37 at the periphery of the droplet discharge head 15 is different between the steps, that is, the wind-velocity of the air-current 37 is different.

When the fluid passes through while contacting the droplet discharge head 15, the fluid conducts the heat of the droplet discharge head 15 to cool the droplet discharge head 15. Here, the air-current 37 having high flow-velocity conducts the heat more quickly than that having low flow-velocity, so that the droplet discharge head 15 contacting the air-current 37 having high flow velocity is cooled more quickly.

In the drawing step, the droplet discharge head 15 is positioned where it contacts the air-current 37 having low flow-velocity. On the other hand, in the cleaning step, the droplet discharge head 15 is positioned where it contacts the air-current 37 having high flow-velocity. Therefore, in a case where the frequency of variation of pressure for pressurizing the cavity 32 is made higher in the cleaning step than the frequency in the drawing step, the temperature of the droplet discharge head 15 is more easily stabilized. Consequently, the functional liquid 33 can be controlled to be discharged with accurate discharge amount.

### Second Embodiment

A droplet discharge device according to a second embodiment of the invention will be described with reference to FIGS. 5 to 7B, and 12 to 14. Members common to the first embodiment are given the same reference numbers.

The different point from the first embodiment is that a temperature sensor is provided to the droplet discharge head 15 that is shown in FIG. 2 so as to be able to detect a temperature of the droplet discharge head 15.

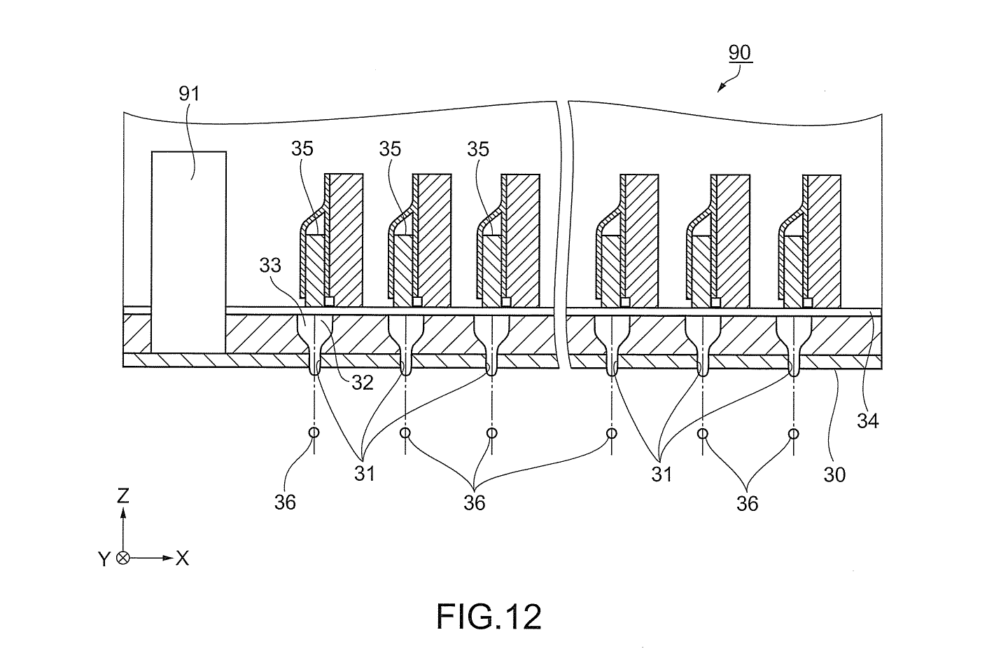

FIG. 12 is a schematic sectional view showing a major part of a structure of a droplet discharge head. In particular, as shown in FIG. 12, a temperature sensor 91 is provided to this droplet discharge head 90 in this embodiment. It is preferable that the temperature sensor 91 be capable of converting a temperature of the droplet discharge head 90 into an electric signal. In this embodiment, a thermistor is used, for example. The temperature sensor 91 is disposed so as to contact a nozzle plate 30, being able to measure a temperature of the nozzle plate 30.

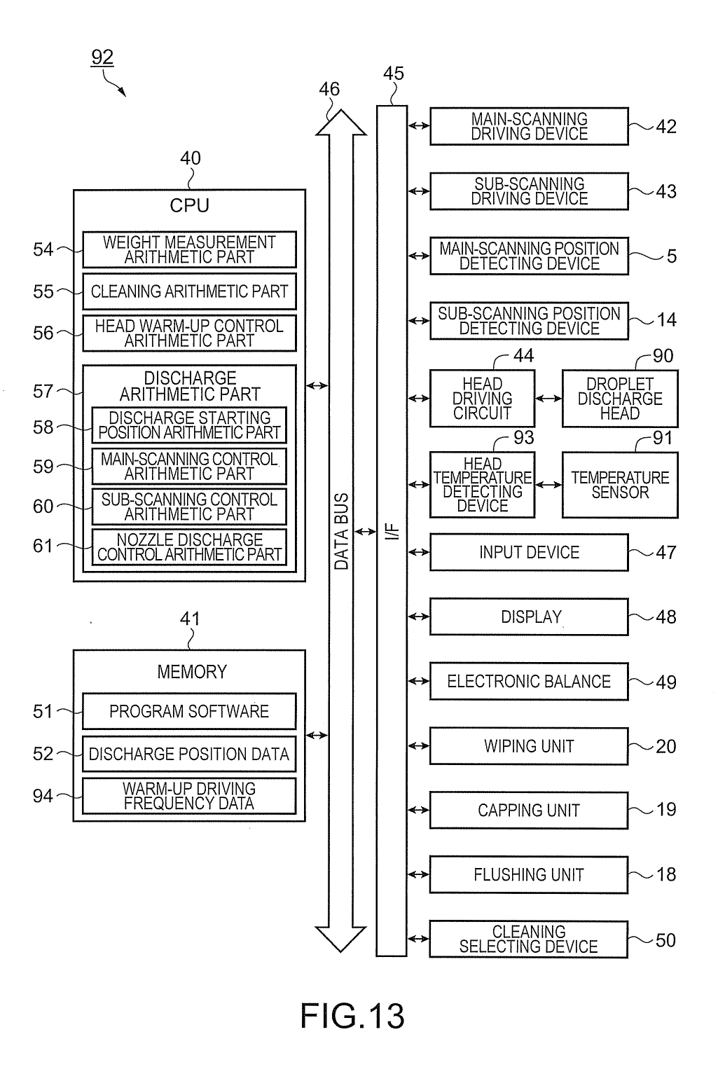

FIG. 13 is a block diagram showing electric control of the droplet discharge device. A droplet discharge device 92 is provided with seven droplet discharge heads 90. The temperature sensor 91 is provided to each of the droplet discharge heads 90. That is, seven droplet discharge heads 90 are arranged, so that seven temperature sensors 91 are provided.

The temperature sensor 91 is coupled to a head temperature detecting device 93 as a measurement part. The head temperature detecting device 93 is coupled through the input/output interface 45 and the data bus 46 to the CPU 40.

The temperature sensor 91 outputs a voltage signal corresponding to the temperature of the droplet discharge head 90 to the head temperature detecting device 93. The head temperature detecting device 93 converts the voltage signal that is received into a digital signal corresponding to the temperature so as to output it to the CPU 40. The head temperature detecting device 93 receives the voltage signal of the temperature sensor 91 provided to each of the droplet discharge heads 90. The head temperature detecting device 93 outputs the digital signal corresponding to the temperature of each of the droplet discharge heads 90 to the CPU 40. Therefore, the CPU 40 can detect the temperature of each of the droplet discharge heads 90.

A memory 41 stores a warm-up driving frequency data 94. The warm-up driving frequency data 94 exhibits a relation between the temperature of the droplet discharged head 90 and the frequency for driving the piezoelectric element 35 when the droplet discharged head 90 is warm-up driven.

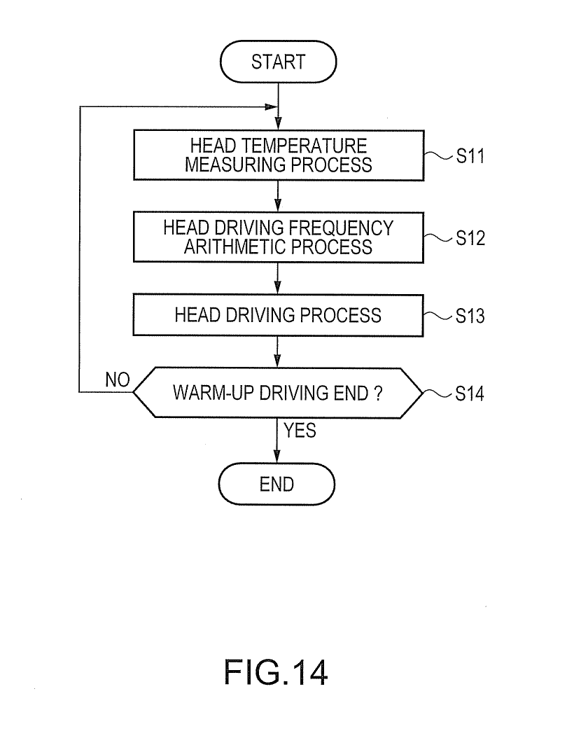

FIG. 14 is a flow chart showing a process for warm-up driving the droplet discharge head.

In FIG. 14, a step S11 corresponds to a head temperature measuring step. In the step, the temperature of the droplet discharge head is measured with the head temperature detecting device. The process goes to a step S12. The step S12 corresponds to a head driving frequency arithmetic step. In the step, a frequency for driving the droplet discharge head is calculated correspondingly to the temperature of the droplet discharge head. The process goes to a step S13. The step S13 corresponds to a head driving step. In the step, a piezoelectric element is driven depending on the frequency calculated at the step S12 so as to pressurize the cavity. The process goes to a step S14. The step S14 corresponds to a step judging whether the warm-up drive is ended. The CPU judges whether the temperature of the droplet discharge head is at a predetermined temperature. Further, the CPU judges whether a process following to the warm-up drive is ready. If the temperature of the droplet discharge head is not at the predetermined temperature and the process following to the warm-up drive is not ready (in a case of “NO”), the process returns to the step S11. If the temperature of the droplet discharge head is at the predetermined temperature and the process following to the warm-up drive is ready (in a case of “YES”), the process for warm-up driving the droplet discharge head is ended.

Here, the method for warm-up driving the droplet discharge head will be described in detail corresponding to the steps of FIG. 14 with reference to FIGS. 5 to 7B, and 13.

In the step S11, the temperature sensor 91 that is shown in FIG. 13 outputs the voltage signal corresponding to the temperature of the droplet discharge heads 90 to the head temperature detecting device 93. The head temperature detecting device 93 converts the voltage signal of each of the droplet discharge heads 90 into a digital signal to output it to the CPU 40. Therefore, the CPU 40 recognizes the temperature of each of the droplet discharge heads 90.

In the step S12, the head warm-up control arithmetic part 56 of the CPU 40 calculates to set the driving voltage and the frequency for driving the piezoelectric element 35. The CPU 40 sets the driving voltage at an extent not discharging the fine droplets 36 from the nozzle 31. Further, the CPU 40 calculates to set the frequency corresponding to the temperature of each of the droplet discharge heads 90.

In particular, the CPU 40 calculates to set the frequency for driving the piezoelectric element 35 to be high in a case where the temperature of the droplet discharge heads 90 is low, compared to the frequency for driving in a case where the temperature is high.

A threshold value of the droplet discharge heads 90 is set to be stored in the warm-up driving frequency data 94. The CPU 40 compares the threshold value of the droplet discharge heads 90 to the temperature of the droplet discharge heads 90 based on the signal outputted from the head temperature detecting device 93. If the temperature of the droplet discharge heads 90 is higher than the threshold value, the first non-discharge driving waveform 74 shown in FIG. 6C is selected. On the other hand, if the temperature of the droplet discharge heads 90 is lower than the threshold value, the second non-discharge driving waveform 79 shown in FIG. 7B is selected. That is, in a case where the temperature of the droplet discharge heads 90 is low, the frequency for driving the piezoelectric element 35 is made high to increase the amount of heat for heating the droplet discharge heads 90, increasing the temperature.

In the step S13, the CPU 40 outputs the driving voltage and the frequency for driving the piezoelectric element 35 to the waveform controlling circuit 62 of the head driving circuit 44 shown in FIG. 5. The head driving circuit 44 outputs the driving waveform shaped by specified driving voltage and frequency to each of the droplet discharge head 90. The piezoelectric element 35 of the droplet discharge heads 90 pressurizes the cavity 32 depending on the driving waveform so as to heat the droplet discharge heads 90.

In the step S14, if each of the droplet discharge heads 90 is at a predetermined temperature and the following process is ready, the warm-up drive of the droplet discharge heads 90 is ended.

Advantageous effects of the second embodiment of the invention are now described in addition to those of the first embodiment.

(1) According to the embodiment, the droplet discharge device 92 includes the head temperature detecting device 93 so as to measure the temperature of the droplet discharge heads 90. In a case where the droplet discharge heads 90 does not discharge the fine droplets 36, they are warm-up driven. The head warm-up control arithmetic part 56 controls a signal for driving the piezoelectric element 35 correspondingly to the temperature of the droplet discharge heads 90. If the temperature of the droplet discharge heads 90 is high, the piezoelectric element 35 pressurizes the cavity 32 with low frequency. If the temperature of the droplet discharge heads 90 is low, the piezoelectric element 35 pressurizes the cavity 32 with high frequency.

If the detected temperature of the droplet discharge heads 90 is low, the piezoelectric element 35 is driven with high frequency so as to be able to increase the temperature of the droplet discharge heads 90 more quickly than driven with low frequency. On the other hand, if the temperature of the droplet discharge heads 90 is high, the cavity 32 is pressurized with low frequency to heat with small amount of heat, preventing the temperature of the droplet discharge heads 90 from rising excessively. Therefore, the temperature of the droplet discharge heads 90 is easily stabilized. Consequently, the functional liquid 33 can be controlled to be discharged with accurate discharge amount.

(2) According to the embodiment, the temperature sensor 91 is provided to each of the droplet discharge heads 90. The temperatures of the plurality of the droplet discharge heads 90 are not even, so that temperature of some droplet discharge heads 90 is low and temperature of other droplet discharge heads 90 is high. The head temperature detecting device 93 measures the temperature of each of the droplet discharge heads 90 so as to drive the piezoelectric element 35 with low frequency in the droplet discharge heads 90 having high temperature and drive the piezoelectric element 35 with high frequency in the droplet discharge heads 90 having low temperature.

In terms of the plurality of droplet discharge heads 90, in a case where the temperature of the droplet discharge heads 90 is low, the piezoelectric element 35 is driven with high frequency so as to be able to supply larger energy than driven with low frequency, being able to raise the temperature in a short period of time. On the other hand, in a case where the temperature of the droplet discharge heads 90 is high, the vibration plate 34 is driven with low frequency to heat with small heat quantity, being able to prevent the temperature from rising excessively. Therefore, the temperature of the droplet discharge heads 90 is easily stabilized. Consequently, the functional liquid 33 can be controlled to be discharged with accurate discharge amount.

### Third Embodiment

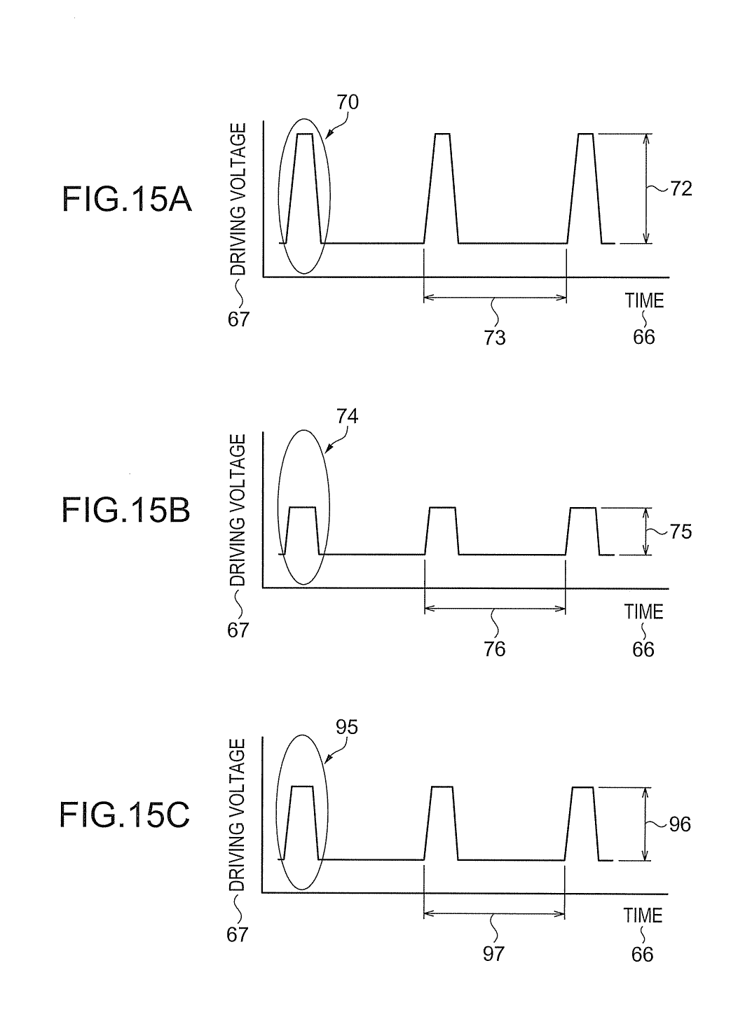

A droplet discharge device according to a third embodiment of the invention will now be described with reference to FIGS. 15A to 15C.

While the piezoelectric element 35 is driven with the waveforms having different frequencies in the first embodiment, the piezoelectric element 35 is driven with waveforms having different voltages in this embodiment.

FIGS. 15A to 15C are graphs for explaining driving waveforms of a droplet discharge head. FIG. 15A shows the discharge driving waveform 70, and FIG. 15B shows the first non-discharge driving waveform 74. The discharge driving waveform 70 and the first non-discharge driving waveform 74 are respectively same as those in the first embodiment. FIG. 15C shows a third non-discharge driving waveform 95. A third non-discharge voltage 96 that is a peak value of the third non-discharge driving waveform 95 is set to be higher than the first non-discharge voltage 75.

A third non-discharge waveform period 97 that is an interval between the third non-discharge driving waveforms 95 is set to have the same time interval as the discharge waveform period 73 and the first non-discharge waveform period 76. In a case where the piezoelectric element 35 is driven with the third non-discharge driving waveform 95 as a driving waveform, the third non-discharge voltage 96 is set not to discharge the fine droplets 36 from the nozzle 31.

There is a case where the droplet discharge head 15 is heated such that the piezoelectric element 35 is warm-up driven so as to pressurize the cavity 32 at an extent not discharging the fine droplets 36. In a case where the flow velocity of the air-current 37 is low at the periphery of the droplet discharge head 15, the first non-discharge driving waveform 74 is inputted into the piezoelectric element 35 of the droplet discharge head 15. On the other hand, when the flow velocity of the air-current 37 is high at the periphery of the droplet discharge head 15, the second non-discharge driving waveform 79 is inputted into the piezoelectric element 35 of the droplet discharge head 15.

The third non-discharge voltage 96 of the third non-discharge driving waveform 95 is higher than the first non-discharge voltage 75 of the first non-discharge driving waveform 74. Therefore, larger energy is supplied to the piezoelectric element 35 so as to supply large amount of heat to the droplet discharge head 15. The large amount of heat is supplied to the droplet discharge head 15 of which heat is easily drawn, so that the temperature of the droplet discharge head 15 is easily stabilized. Consequently, the functional liquid 33 can be controlled to be discharged with accurate discharge amount. Thus, the same advantageous effect as the first embodiment can be obtained.

### Fourth Embodiment

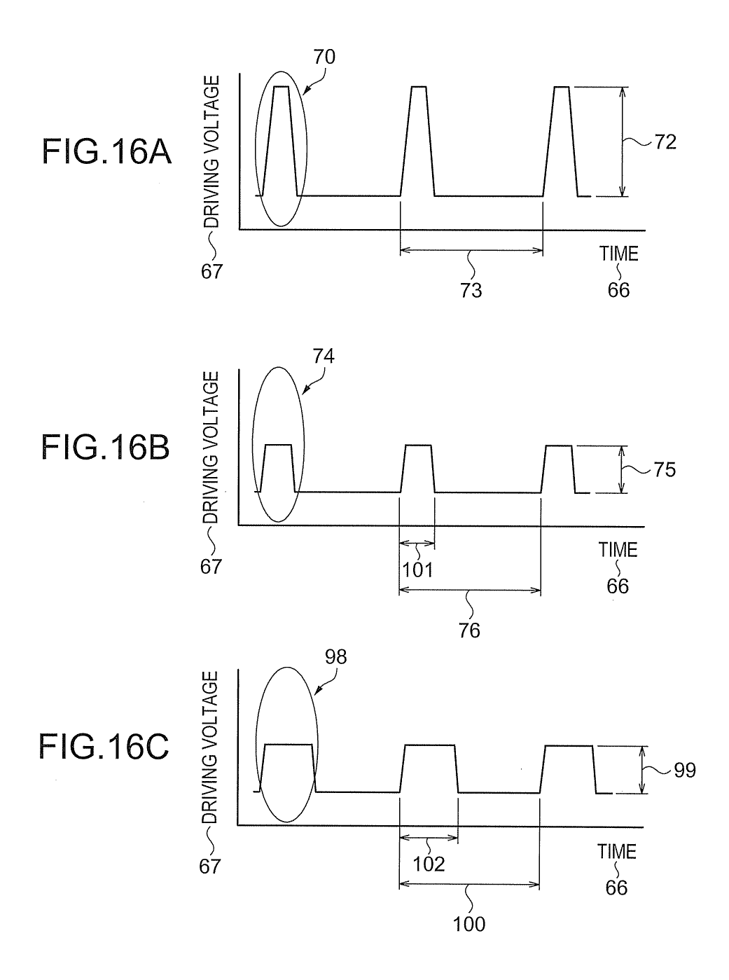

A droplet discharge device according to a fourth embodiment of the invention will now be described with reference to FIGS. 16A to 16C.

While the piezoelectric element 35 is driven with the driving waveforms having different frequencies in the first embodiment, the piezoelectric element 35 is driven with the driving waveforms having different duty ratios in this embodiment.

FIGS. 16A to 16C are graphs for explaining driving waveforms of a droplet discharge head. FIG. 16A shows the discharge driving waveform 70, and FIG. 16B shows the first non-discharge driving waveform 74. The discharge driving waveform 70 and the first non-discharge driving waveform 74 are respectively same as those in the first embodiment. FIG. 16C shows a fourth non-discharge driving waveform 98.

A fourth non-discharge voltage 99 that is a peak value of the fourth non-discharge driving waveform 98 is set to be the same voltage as the first non-discharge voltage 75. In a case where the piezoelectric element 35 is driven with the fourth non-discharge driving waveform 98 as a driving waveform, the fourth non-discharge voltage 99 is set to be at an extent not discharging the fine droplets 36 from the nozzle 31. A fourth non-discharge waveform period 100 that is an interval between the fourth non-discharge driving waveforms 98 is set to have the same time interval as the discharge waveform period 73 and the first non-discharge waveform period 76.

A pulse width of the first non-discharge driving waveform 74 is denoted as a first non-discharge waveform pulse width 101, and a pulse width of the fourth non-discharge driving waveform 98 is denoted as a fourth non-discharge waveform pulse width 102. The fourth non-discharge waveform pulse width 102 is set to be wider than the first non-discharge waveform pulse width 101. A value derived by dividing a pulse width by a waveform period is a duty ratio. A duty ratio of the fourth non-discharge driving waveform 98 is set to be larger than that of the first non-discharge driving waveform 74.

In a case where the piezoelectric element 35 is driven with a driving waveform having large duty ratio, time for applying a voltage to the piezoelectric element 35 is longer than that in a case where the piezoelectric element 35 is driven with a driving waveform having small duty ratio. The piezoelectric element 35 contracts and generates heat while being applied with voltage. Therefore, in a case where the piezoelectric element 35 is driven with a driving waveform having a large duty ratio, larger amount of heat is supplied to the droplet discharge head 15.

There is a case where the droplet discharge head 15 is heated such that the piezoelectric element 35 is warm-up driven so as to pressurize the cavity 32 at an extent not discharging the fine droplets 36. In a case where the flow-velocity of the air-current 37 is low at the periphery of the droplet discharge head 15, the first non-discharge driving waveform 74 is inputted into the piezoelectric element 35 of the droplet discharge head 15. On the other hand, in a case where the flow-velocity of the air-current 37 is high at the periphery of the droplet discharge head 15, the fourth non-discharge driving waveform 98 is inputted into the piezoelectric element 35 of the droplet discharge head 15.

Since the duty ratio of the fourth non-discharge driving waveform 98 is larger than that of the first non-discharge driving waveform 74, larger amount of heat is supplied to the piezoelectric element 35. The large amount of heat is supplied to the droplet discharge head 15 of which heat is easily drawn, so that the temperature of the droplet discharge head 15 is easily stabilized. Consequently, the functional liquid 33 can be controlled to be discharged with accurate discharge amount. Thus, the same advantageous effect as the first embodiment can be obtained.

Here, it should be understood that the invention is not limited to the embodiments described above, and various changes and modification can be made. Modifications will now be described.

### [Modification 1]

While the piezoelectric element 35 pressurizes the cavity 32 in the first to fourth embodiments, other means may be used for pressurizing the cavity 32. For example, the fine droplets 36 may be discharged by deforming the vibration plate with static electricity, or by heating an electrode to generate bubbles in the functional liquid 33. In both cases, a head is driven not with the piezoelectric element 35 but with an electrode, so that the head does not need the piezoelectric element 35. Thus, the head can be manufactured with good productivity.

### [Modification 2]

While the frequency of the driving waveform for driving the piezoelectric element 35 is changed so as to change the amount of heat that is supplied to the droplet discharge head 90 in the second embodiment, the voltage of the driving waveform may be changed so as to change the amount of heat that is supplied to the droplet discharge head 90 as is the case with the third embodiment. In this case as well, the same advantageous effect as the second embodiment can be obtained. In addition, a method for driving the droplet discharge head 90 with good discharge characteristics can be selected.

### [Modification 3]

While the frequency of the driving waveform for driving the piezoelectric element 35 is changed so as to change the amount of heat that is supplied to the droplet discharge head 90 in the second embodiment, the duty ratio of the driving waveform may be changed so as to change the amount of heat that is supplied to the droplet discharge head 90 as is the case with the fourth embodiment. In this case as well, the same advantageous effect as the second embodiment can be obtained. In addition, a method for driving the droplet discharge head 90 with good discharge characteristics can be selected.

### [Modification 4]

In the first embodiment, the wind velocity of the air-current 37 at the periphery of the droplet discharge head 15 is higher in the cleaning step shown in FIG. 3B than in the drawing step shown in FIG. 3A, so that the frequency of the driving waveform for the piezoelectric element 35 in the cleaning step is made high. On the other hand, in a case the wind velocity of the air-current 37 at the periphery of the droplet discharge head 15 is higher in the drawing step than in the cleaning step, the frequency of the driving waveform for the piezoelectric element 35 in the drawing step may be made high. An area in which the frequency is made high may be changed depending on a state of the process.

### [Modification 5]

In the first embodiment, in a case where the fine droplets 36 are not discharged from the nozzle 31, the piezoelectric element 35 is driven by switching two kinds of periods between driving waveforms of the first non-discharge waveform period 76 and the second non-discharge waveform period 81. Kinds of the periods of driving waveform are not limited to two but may be three or more. If there are more selectable kinds of periods, more appropriate control can be performed.

Kinds of the periods may be further increased to change the periods between the driving waveforms continuously. Since kinds of selectable periods are increased, further more appropriate control can be performed.

In the same manner, steps of the frequency, the driving voltage, and the duty ratio of the driving waveform may be increased more than two or continuously in the second to fourth embodiments as well. Since selectable steps are increased, more appropriate control can be performed.

In a case where the frequency of the driving waveform is continuously changed, the relation between the temperature of the droplet discharge head 90 and the frequency of the driving waveform may be represented in formulas such as a quartic function and an exponent function. In this case, an appropriate frequency of the driving waveform can be easily derived with respect to the temperature of the droplet discharge head 90, being able to control in good productivity. This may be applied in controlling by changing the driving voltage of the driving waveform and the duty ratio.

### [Modification 6]

In the first and second embodiments, the frequency of the driving waveform for driving the piezoelectric element 35 is changed so as to change the amount of heat that is supplied to the droplet discharge heads 15, 90. In the third embodiment, the driving voltage of the driving waveform for driving the piezoelectric element 35 is changed so as to change the amount of heat that is supplied to the droplet discharge head 15. Moreover, in the fourth embodiment, the duty ratio of the driving waveform for driving the piezoelectric element 35 is changed so as to change the quantity of heat to be supplied to the droplet discharge head 15.

The piezoelectric element 35 may be driven with a driving waveform shaped by combining the frequency, the driving voltage, and the duty ratio. In any combination, the piezoelectric element 35 is preferably driven corresponding to the heat released by the droplet discharge head 15. Either method provides a similar advantageous effect. In addition, a controlling method by which the droplet discharge heads 15, 90 are easily controlled can be selected.

### [Modification 7]

The thermistor is provided as the temperature sensor 91 in the second embodiment, but other means may be used as long as it can detect the temperature. Examples of the temperature sensor 91 may include a thermo couple, a platinum temperature measurement resistor, and a crystal oscillator. The temperature of the functional liquid 33 can be accurately detected with a sensor that is sensitive to the temperature.

### [Modification 8]

While the temperature sensor 91 detects the temperature of the nozzle plate 30 in the second embodiment, the temperature sensor 91 may detect temperatures of the vibration plate 34 and the cavity 32. Further, the temperature sensor 91 may directly detect the temperature of the functional liquid 33 in the cavity 32. A temperature responding part of the temperature sensor 91 may be disposed to contact the vibration plate 34, the cavity 32, and the functional liquid 33 in the cavity 32 so as to measure the temperature of the droplet discharge head 90. The temperature sensor 91 may be formed to be easily arranged depending on the shape of the droplet discharge head 90.

### [Modification 9]

In FIG. 9 according to the first embodiment, the step S1 shows the cleaning step that is one of the maintenance processes. Here, the step S2 may be a discharge amount measuring step. The discharge amount measuring step is one of the maintenance processes. In the step, the fine droplets 36 are discharged to the electronic balance 49 and the weight of the fine droplets 36 is measured. In this case as well, the temperature of the droplet discharge head 15 can be easily stabilized as is the case with the first embodiment. Consequently, the functional liquid 33 can be controlled to be discharged with accurate discharge amount.

### [Modification 10]

In FIG. 9 according to the first embodiment, the step S1 shows the cleaning step that is one of the maintenance processes. Here, the step S2 may be a waiting step. The waiting step is one of the maintenance processes. In the step, the droplet discharge head 15 does not discharge the fine droplets 36 but waits. In this case as well, the temperature of the droplet discharge head 15 can be easily stabilized as is the case with the first embodiment. Consequently, the functional liquid 33 can be controlled to be discharged with accurate discharge amount.

What is claimed is:

1. A droplet discharge device, comprising:
a droplet discharge head including a cavity, a nozzle that communicate with the cavity and a pressurizing part that pressurizes the cavity, the droplet discharge head discharging a functional liquid from the nozzle due to pressurizing the cavity; and
a table moving the work relatively to the droplet discharge head, wherein;
wherein the pressurizing part pressurizes a cavity a plurality of times in succession so as to vary pressure on the functional liquid to an extent not discharging the functional liquid from the nozzle, if the functional liquid is not discharged from the nozzle; and
the pressurizing part changes a frequency of the variation of the pressure applied to the cavity.

2. The droplet discharge device according to claim 1, further comprising:
a blowing part producing air-current that transfers heat generated by the droplet discharge device and remove the heat from the device, wherein
the droplet discharge head is located at both a first position where a wind-velocity of the wind blow is high and a second position where a wind-velocity of the wind blow is low, if the functional liquid is not discharged from the nozzle,
wherein the frequency of the variation of the pressure in a case when the droplet discharge head is located at the first position is higher than the frequency of the variation of the pressure in a case when the droplet discharge head is located at the second position.

3. The droplet discharge device according to claim 2, wherein
a plurality of the droplet discharge heads are included, and
in a case where the functional liquid is not discharged from the nozzle, the pressurizing part pressurizes the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

4. The droplet discharge device according to claim 1, further comprising:
a measurement part measuring a temperature of the droplet discharge head, wherein
in a case where the functional liquid is not discharged from the nozzle, the pressurizing part pressurizes the portion defining a cavity with a high frequency of variation of pressure for pressurizing the portion defining a cavity when the temperature of the droplet discharge head is low, compared to a frequency of variation of pressure for pressurizing the portion defining a cavity when the temperature of the droplet discharge head is high.

5. The droplet discharge device according to claim 4, wherein
a plurality of the droplet discharge heads are included, and
in a case where the functional liquid is not discharged from the nozzle, the pressurizing part pressurizes the portion defining a cavity with a high frequency of variation of pressure for pressurizing the portion defining a cavity when the temperature of the droplet discharge head is low, compared to a frequency of variation of pressure for pressurizing the portion defining a cavity when the temperature of the droplet discharge head is high.

6. The droplet discharge device according to claim 1, wherein the pressurizing part changes amplitude of pressure for pressurizing the portion defining a cavity instead of the frequency of variation of pressure for pressurizing the portion defining a cavity, so as to pressurize the portion defining a cavity.

7. The droplet discharge device according to claim 1, wherein the pressurizing part changes a duty ratio of variation of pressure for pressurizing the portion defining a cavity instead of the frequency of variation of pressure for pressurizing the portion defining a cavity, so as to pressurize the portion defining a cavity.

8. A method for drawing, comprising:
(a) pressurizing the portion defining the cavity with a pressurizing part of a droplet discharge head;
(b) discharging a functional liquid from a nozzle communicating with the portion defining a cavity to a work; and
one of (c) cleaning the nozzle, (d) measuring a discharge amount of the functional liquid discharged from the nozzle, and (e) waiting without discharge the functional liquid, wherein
in a case where the functional liquid is not discharged from the nozzle, the pressurizing part pressurizes the portion defining a cavity a plurality of times in succession with a different frequency between the steps (a), (b) and the steps (c), (d), (e) so as to change pressure on the functional liquid at an extent not discharging the functional liquid from the nozzle.

9. A method for drawing, comprising:
pressurizing a portion defining a cavity with a pressurizing part of a droplet discharge head;
discharging a functional liquid from a nozzle communicating with the portion defining a cavity to a work; and
pressurizing the portion defining a cavity a plurality of times in succession with the pressurizing part at an extent not discharging the functional liquid from the nozzle so as to change pressure on the functional liquid in a case where the functional liquid is not discharged from the nozzle, wherein
the pressurizing part pressurizes the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

10. A method for drawing, comprising:
pressurizing a portion defining a cavity with a pressurizing part of a droplet discharge head;
discharging a functional liquid from a nozzle communicating with the portion defining a cavity to a work;
pressurizing the portion defining a cavity a plurality of times in succession with the pressurizing part at an extent not discharging the functional liquid from the nozzle so as to change pressure on the functional liquid in a case where the functional liquid is not discharged from the nozzle; and
measuring a temperature of the droplet discharge head with a measurement part, wherein
the pressurizing part pressurizes the portion defining a cavity with a high frequency of variation of pressure for pressurizing the portion defining a cavity when a temperature of the droplet discharge head is low, compared to a frequency of variation of pressure for pressurizing the portion defining a cavity when the temperature of the droplet discharge head is high.

11. The method for drawing according to claim 8, wherein the pressurizing part changes amplitude of pressure for pressurizing the portion defining a cavity instead of the frequency of variation of pressure for pressurizing the portion defining a cavity, so as to pressurize the portion defining a cavity.

12. The method for drawing according to claim 8, wherein the pressurizing part changes a duty ratio of variation of pressure for pressurizing the portion defining a cavity instead of the frequency of variation of pressure for pressurizing the portion defining a cavity, so as to pressurize the portion defining a cavity.

13. A method for controlling a droplet discharge head that pressurizes a portion defining a cavity with a pressurizing part thereof so as to discharge a functional liquid from a nozzle communicating with the portion defining a cavity to a work, comprising:
pressurizing the portion defining a cavity with the pressurizing part in response to a driving signal from a pressurization controlling part so as to change pressure on the functional liquid, wherein
in a case where the droplet discharge head does not discharge the functional liquid from the nozzle thereof, the pressurizing part pressurizes the portion defining a cavity a plurality of times in succession at an extent not discharging the functional liquid from the nozzle; and the pressurization controlling part changes a frequency of variation of pressure for pressurizing the portion defining a cavity so as to control the pressurizing part.

14. The method for controlling a droplet discharge head according to claim 13, wherein the pressurization controlling part controls a plurality of the droplet discharge heads all together, and
in a case where the pressurization controlling part does not discharge the functional liquid from the nozzle thereof, the pressurization controlling part controls the pressurizing part such that the pressurizing part pressurizes the portion defining a cavity with a high frequency of variation of pressure for pressurizing the portion defining a cavity when the droplet discharge head is positioned where a wind-velocity is high, compared to a frequency of variation of pressure for pressurizing the portion defining a cavity when the droplet discharge head is positioned where the wind-velocity is low.

15. The method for controlling a droplet discharge head according to claim 13, wherein in a case where the functional liquid is not discharged from the nozzle,
a temperature of the droplet discharge head is measured with a measurement part, and
the pressurization controlling part controls the pressurizing part such that the pressurizing part pressurizes the portion defining a cavity with a high frequency of variation of pressure for pressurizing the portion defining a cavity when a temperature of the droplet discharge head is low, compared to a frequency of variation of pressure for pressurizing the portion defining a cavity when the temperature of the droplet discharge head is high.

16. The method for controlling a droplet discharge head according to claim 13, wherein the pressurization controlling part controls the pressurizing part such that the pressurizing part changes amplitude of pressure for pressurizing the portion defining a cavity instead of the frequency of variation of pressure for pressurizing the portion defining a cavity, so as to pressurize the portion defining a cavity.

17. The method for controlling a droplet discharge head according to claim 13, wherein the pressurization controlling part controls the pressurizing part such that the pressurizing part changes a duty ratio of variation of pressure for pressurizing the portion defining a cavity instead of the frequency of variation of pressure for pressurizing the portion defining a cavity, so as to pressurize the portion defining a cavity.
